(19) United States
(12) Patent Application Publication
(10) Pub. No.: US 2024/0305987 A1
(43) Pub. Date: Sep. 12, 2024

(54) WIRELESS PACKET HEADER PROTECTION

(71) Applicant: QUALCOMM Incorporated, San Diego, CA (US)

(72) Inventors: Abhishek Pramod Patil, San Diego, CA (US); Sai Yiu Duncan Ho, San Diego, CA (US); Alfred Asterjadhi, San Diego, CA (US); Jouni Kalevi Malinen, Tuusula (FI); George Cherian, San Diego, CA (US); Yanjun Sun, San Diego, CA (US); Gaurang Naik, San Diego, CA (US); Abdel Karim Ajami, San Diego, CA (US)

(21) Appl. No.: 18/180,784

(22) Filed: Mar. 8, 2023

(51) Int. Cl. H04W 12/106; H04W 12/0431

(52) U.S. Cl. CPC H04W 12/106; H04W 12/0431

(57) ABSTRACT

This disclosure provides methods, components, devices and systems for wireless packet header protection. Some aspects more specifically relate to supporting header integrity checks to prevent processing of maliciously altered packet headers. In some examples, a wireless communication device may generate header integrity check information based on one or more fields of a header of a first data packet. The wireless communication device may generate, based on the header integrity check information, the first data packet or a second data packet. For example, the header of the first data packet may include the header integrity check information, or a value derived therefrom. Alternatively, the header integrity check information (or the derived value) may be included in a subsequently transmitted packet (e.g., the second data packet) A receiving device may use the received header integrity check information to perform a header integrity check before processing the header of the first data packet.

### TECHNICAL FIELD

This disclosure relates generally to wireless communication, and more specifically, to wireless packet header protection. Some aspects more specifically relate to supporting integrity verification of one or more fields of headers, particularly medium access control (MAC) headers, of packets communicated within wireless communication networks.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, data encryption is a primary tool in securing wireless communications. For example, data packets communicated by APs and STAs may include payloads with encrypted data units that are encrypted using various encryption protocols, such as Galois Counter Mode Protocol (GCMP) or Counter Mode Cipher Block Chaining Message Authentication Code Protocol (CCMP). Because the data in the payload is encrypted, the data may be protected from decryption by a malicious entity that intercepts a data packet for use in cyberattacks or to steal private data. Encryption protocols typically focus on protecting and securing data in the payload of data packets, and often times do not encrypt or protect fields in a header of a data packet. Although some fields in a header are not likely to be useful in a cyberattack or to provide valuable information, other fields may carry information that can be used to carry out an attack on a wireless network. For example, a portion of a header referred to as a medium access control (MAC) header may carry information that influences a receiving device's behavior, such as indication of retry, more data, power-saving, triggering, buffer and other status information, or the like. New cyberattacks have shown that such information can be used in denial of service attacks or to affect the receiving device's power state, thereby degrading performance and reliability and increasing power drain of devices in WLANs.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes at least one memory and at least one processor communicatively coupled with the at least one memory. The at least one processor is operable to cause the wireless communication device to generate header integrity check information based on one or more fields of a header for a first data packet. The header integrity check information is distinct from message integrity check information for the first data packet, and the message integrity check information is based on a payload of the first data packet. The at least one processor is also operable to cause the wireless communication device to generate, based on the header integrity check information, the first data packet or a second data packet. The at least one processor is further operable to cause the wireless communication device to transmit the first data packet or the second data packet.

Another innovative aspect of the subject matter described in this disclosure can be implemented in a method for wireless communication. The method includes generating header integrity check information based on one or more fields of a header for a first data packet. The header integrity check information is distinct from message integrity check information for the first data packet, and the message integrity check information is based on a payload of the first data packet. The method also includes generating, based on the header integrity check information, the first data packet or a second data packet. The method further includes transmitting the first data packet or the second data packet.

Another innovative aspect of the subject matter described in this disclosure can be implemented in a wireless communication device. The wireless communication device includes at least one memory and at least one processor communicatively coupled with the at least one memory. The at least one processor is operable to cause the wireless communication device to receive a first data packet that includes integrity check information that is based on one or more fields of a header of the first data packet or one or more fields of a header of a second data packet that is received prior to reception of the first data packet. The at least one processor is also operable to cause the wireless communication device to perform, based on the integrity check information, a header integrity check on the header of the first data packet or the header of the second data packet. The at least one processor is further operable to cause the wireless communication device to process, based on success of the header integrity check, the header of the first data packet or the header of the second data packet.

Another innovative aspect of the subject matter described in this disclosure can be implemented in a method for wireless communication. The method includes receiving a first data packet that includes integrity check information that is based on one or more fields of a header of the first data packet or one or more fields of a header of a second data packet that is received prior to reception of the first data packet. The method also includes performing, based on the integrity check information, a header integrity check on the header of the first data packet or the header of the second data packet. The method further includes processing, based on success of the header integrity check, the header of the first data packet or the header of the second data packet.

In some examples of the methods and wireless communication devices, the header integrity check information is generated based further on one or both of: a second packet number that is distinct from a first packet number included in the header of the first data packet; or a second encryption key that is distinct from a first encryption key used to encrypt the payload of the first data packet.

In some examples of the methods and wireless communication devices, the first packet number is included in a first range of packet numbers that is allocated to payload encryption, and the second packet number is included in a second range of packet numbers that is allocated to header integrity.

In some examples of the methods and wireless communication devices, the second packet number is greater than the first packet number, and the first packet number and the second packet number are included in a range of packet numbers that is allocated to payload encryption.

In some examples, the methods and wireless communication devices may generate a pair of pairwise encryption keys during association with another wireless communication device. The pair of pairwise encryption keys includes the first encryption key and the second encryption key.

In some examples of the methods and wireless communication devices, the methods and wireless communication devices generate the first data packet and transmit the first data packet. A header integrity check field of the header of the first data packet includes the header integrity check information.

In some examples of the methods and wireless communication devices, the methods and wireless communication devices generate the first data packet and transmit the first data packet. A message integrity check field of the first data packet includes a value that is based on the header integrity check information and the message integrity check information.

In some examples of the methods and wireless communication devices, the methods and wireless communication devices generate the second data packet and transmit the second data packet after transmission of the first data packet. A field of a header of the second data packet or a field of the second data packet is based on the header integrity check information.

In some examples, the methods and wireless communication devices may transmit one or more dummy frames associated with generation of the header integrity check information. The methods and wireless communication devices generate the first data packet based on the header integrity check information and transmit the first data packet after transmission of the one or more dummy frames.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point and one or more wireless stations.

FIG. 3 shows an example physical layer (PHY) protocol data unit (PPDU) usable for communications between a wireless access point (AP) and one or more wireless stations (STAs).

FIG. 4 shows a hierarchical format of an example PPDU usable for communications between a wireless AP and one or more wireless STAs.

FIG. 5 shows an example of a medium access protocol (MAC) header usable for communications between a wireless access point and one or more wireless stations.

FIG. 6 shows a block diagram of an example wireless communication system that supports header integrity verification.

FIG. 7 shows a block diagram of an example system architecture that is configured to generate an encrypted MAC PDU (MPDU) with header integrity check information.

FIG. 8 shows a block diagram of an example system architecture that is configured to generate header integrity check information for use with a null frame or an encrypted MPDU to be retransmitted.

FIG. 9 shows example data packets that support header integrity verification.

FIG. 10 shows a block diagram of another example system architecture that is configured to generate an encrypted MPDU with header integrity check information.

FIG. 11 shows a flowchart illustrating an example process performable by a wireless communication device that supports header integrity verification.

FIG. 12 shows a flowchart illustrating another example process performable by a wireless communication device that supports header integrity verification.

FIG. 13 shows a block diagram of an example wireless communication device that supports header integrity verification.

FIG. 14 shows a block diagram of an example wireless communication device that supports header integrity verification.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to communication, and more particularly, to wireless packet header protection. Some aspects more specifically relate to supporting integrity verification of one or more fields of headers, particularly medium access control (MAC) headers, of packets communicated within wireless communication networks. In some examples, a wireless communication device may generate header integrity check information based on one or more fields of a first data packet that is scheduled for wireless transmission by the wireless communication device. The first data packet may be a data packet that is to be retransmitted (e.g., retried), such as due to an error in receipt of the first data packet by a receiving device, and the header integrity check information may be a value that is generated by application of a hash function or other operations to one or more fields of the header, such that the header integrity check information is distinct from message integrity check (MIC) information that is generated based at least on a payload of the first data packet. The wireless communication device may generate, based on the header integrity check information, either the first data packet or a second data packet, and the wireless communication device may transmit the generated data packet (e.g., the first data packet or the second data packet).

In some implementations, the first data packet is generated based on the header integrity check information, such as by populating a field or subfield of the header with the header integrity check information or populating a field or subfield in another part of the first data packet with a value based on the header integrity check information and the MIC information (e.g., a result of an exclusive-OR (XOR) operation performed based on the header integrity check information and the MIC information). In some such implementations, generation of the header integrity check information is fast enough to be completed prior to generation of the other fields of the first data packet, such that the header integrity check information, or a value derived therefrom, is capable of being inserted into the first data packet prior to its transmission. In some other implementations, generation of the header integrity check information may take longer than generation of the other fields of the first data packet, and as such, the first data packet may already be transmitted by the time of completion of the header integrity check information. In such implementations, the second data packet is generated based on the header integrity check information, in the same manner as described for the first data packet, and transmitted after transmission of the first data packet. A receiving device receives the first data packet and waits until receipt of the second data packet to perform a header integrity check on the first data packet. For example, the receiving device may be preconfigured with or may receive signaling that indicates a number n of a subsequent nth data packet that includes header integrity check information that corresponds to a currently received data packet. In some other implementations in which generation of the header integrity check information takes longer than generation of the other fields of the first data packet, the wireless communication device may generate and transmit dummy frames until the header integrity check information is completed, such that the header integrity check information, or a value derived therefrom, may be included in the data packet to which it corresponds.

After receipt of the header integrity check information, the receiving device may use the header integrity information, received in either the first data packet or the second data packet, to perform a header integrity check on the header of the first packet. For example, the receiving device may generate a header integrity check value by performing the same operation(s) (e.g., applying the same hash function) to the field(s) of the header of the first data packet, and the header integrity check value may be compared to the received header integrity check information determine if there is a match. If a match is detected, the receiving device verifies the header integrity and may process the header of the first data packet. However, if the header integrity check fails (e.g., if the generated header integrity check value does not match the received header integrity check information), the receiving device may discard the first data packet without processing the header.

Particular aspects of the subject matter described in this disclosure can be implemented to realize one or more of the following potential advantages. In some examples, by including header integrity check information in a data packet or a subsequently transmitted data packet, the described techniques can be used to enable performance of header integrity check operations at a receiving device. For example, a receiving device may generate its own header integrity check information based on a header of a received data packet, and if the generated header integrity check information fails to match the header integrity check information included in the received data packet (or a subsequently received data packet), the receiving device can refrain from processing the header of the data packet. By refraining from processing headers for which the integrity is not verified, the receiving device may avoid processing headers of packets that were generated by a malicious entity that intercepted the data packets sent by a transmitting device and altered one or more fields of the header to perform a cyber attack on the receiving device. For example, the receiving device may refrain from processing a medium access control (MAC) header that has been modified to trigger the receiving device to change a value of a counter or another state that may be used for a denial of service attack or to negatively affect the power state of the receiving device. The header integrity check information may be added to the header or another field of a data packet to provide for this improved protection capability with minimal increase to network overhead, thereby preventing wireless communication devices from being targeted by certain cyberattacks without significantly increasing latency or congestion in a wireless network.

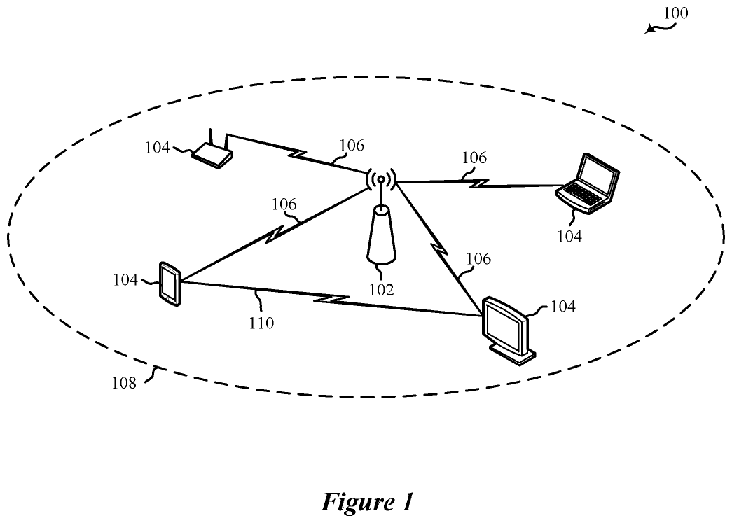

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

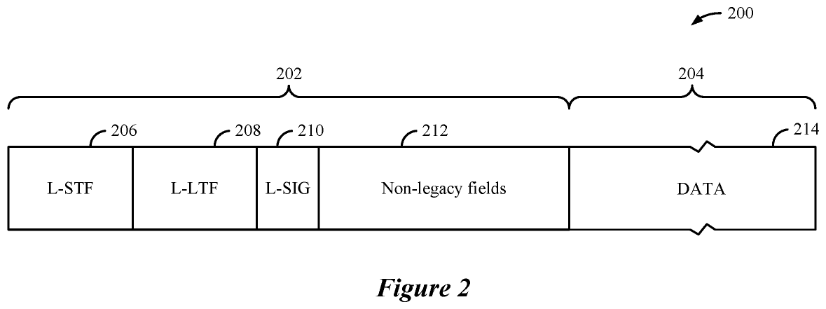

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

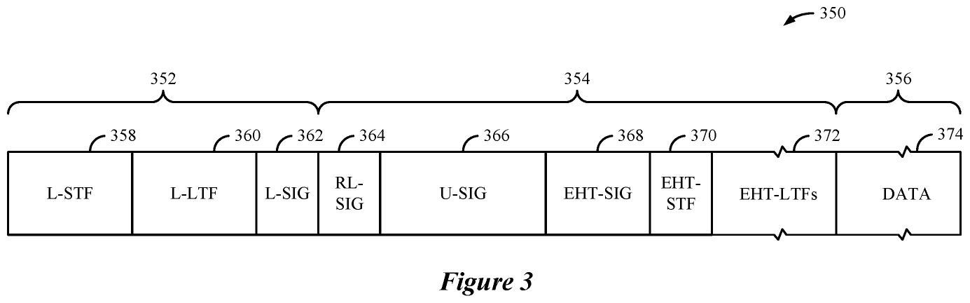

FIG. 3 shows another example PPDU 350 usable for wireless communication between a wireless AP and one or more wireless STAs. The PPDU 350 may be used for SU, OFDMA or MU-MIMO transmissions. The PPDU 350 may be formatted as an Extremely High Throughput (EHT) WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8), or another wireless communication standard. The PPDU 350 includes a PHY preamble including a legacy portion 352 and a non-legacy portion 354. The PPDU 350 may further include a PHY payload 356 after the preamble, for example, in the form of a PSDU including a data field 374.

The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT-or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP to identify and inform one or multiple STAs 104 that the AP has scheduled UL or DL resources for them. EHT-SIG 368 may be decoded by each compatible STA 104 served by the AP 102. EHT-SIG 368 may generally be used by a receiving device to interpret bits in the data field 374. For example, EHT-SIG 368 may include RU allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

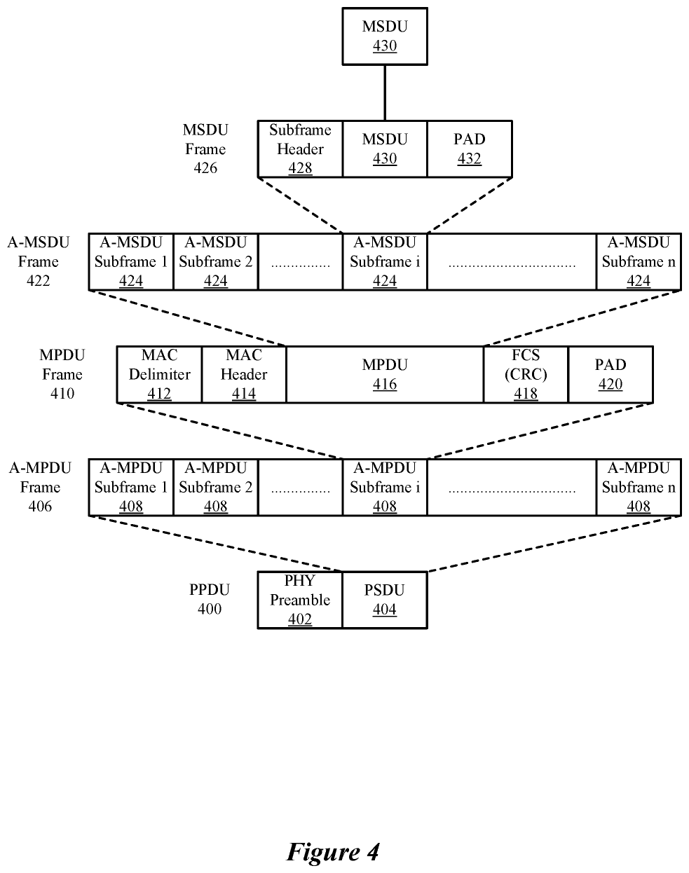

FIG. 4 shows a hierarchical format of an example PPDU usable for communications between a wireless AP 102 and one or more wireless STAs 104. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

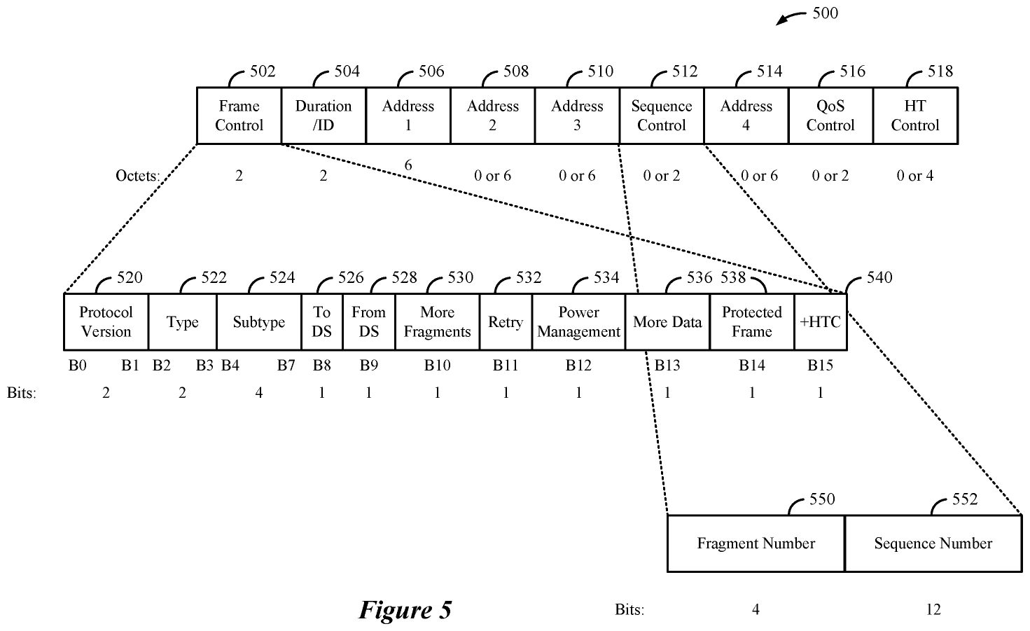

FIG. 5 shows an example of a MAC header 500 usable for communications between a wireless AP 102 and one or more wireless STAs 104. As shown, the MAC header 500 includes a frame control field 502, a duration/identifier (ID) field 504, a first address field 506 (“Address 1”), a second address field 508 (“Address 2”), a third address field 510 (“Address 3”), a sequence control field 512, a fourth address field 514 (“Address 4”), a quality of service (QoS) control field 516, and a high throughput (HT) control field 518. The frame control field 502 may consist of two octets and may include control information associated with a communication that includes the MAC header 500. The duration/ID field 504 may consist of two octets and may indicate a size and ID of the MAC header 500. The address fields 506-510 and 514 may each consist of six octets of address information. The sequence control field 512 may consist of two octets and may include counts (e.g., identifiers in a sequence) related to the MAC header 500 or the communication that includes the MAC header 500. The QoS control field 516 may consist of two octets and may include control information related to QoS parameter(s). The HT control field 518 may consist of four octets and include control information for related to an HT mode. In some implementations, one or more of the second address field 508, the third address field 510, the sequence control field 512, the fourth address field 514, the QoS control field 516, or the HT control field 518 may be optional and may not be included in the MAC header 500.

At least some of the fields 502-518 include one or more subfields. For example, as shown in FIG. 5, the frame control field 502 may include a protocol version subfield 520, a type subfield 522, a subtype subfield 524, a to Distribution System (DS) subfield 526, a from DS subfield 528, a more fragments subfield 530, a retry subfield 532, a power management subfield 534, a more data subfield 536, a protected frame subfield 538, and an HT Control (HTC) present (+HTC) subfield 540. The protocol version subfield 520 may consist of two bits, the type subfield 522 may consist of two bits, the subtype subfield 524 may consist of four bits, and the remainder of the subfields 526-540 may each consist of a single bit. As another example, as shown in FIG. 5, the sequence control field 512 may include a fragment number subfield 550 that consists of four bits and a sequence number subfield 552 that consists of twelve bits.

Typically, encryption protocols used to protect payloads of data packets (e.g., MAC protocol data units (MPDUs)), such as Galois Counter Mode Protocol (GCMP) or Counter Mode Cipher Block Chaining Message Authentication Code Protocol (CCMP), do not protect some or all of the fields of the MAC header 500, particularly for packets that are retransmitted (e.g., retried). For example, if a receiving device does not successfully receive a particular data packet, the encrypted payload of the particular data packet may be included in a new data packet with one or more different values for the fields 502-518 (or the subfields thereof) that is retransmitted. Additionally or alternatively, these fields (or subfields) may not be determined in time to be used during construction of the payload, and therefore may be “masked” (e.g., zeroed or otherwise provided with a temporary value) during additional authentication data (AAD) construction. To illustrate, at least some subfields of the frame control field 502, the duration/ID field 504, at least some subfields of the sequence control field 512, at least some subfields of the QoS control subfield 516, the HT control field 518, or a combination thereof, may be masked during, or not part of, AAD construction and thus not protected by typical packet encryption techniques. For example, the duration/ID field 504 and the HT control field 518 may not be part of AAD construction. As another example, the three least significant bits (LSBs) of the subtype subfield 524 are masked out (e.g., bits 4, 5, and 6), and the last bit (e.g., bit 7) is not modified. As other examples, the retry subfield 532, the power management subfield 534, the more data subfield 536, and the +HTC subfield 540 may be masked out. As another example, the sequence number subfield 552 may be masked out. As another example, all subfields except a TID subfield in the QoS control subfield 516 may be masked, although an aggregated-MAC service data unit (A-MSDU) present subfield may be conditionally protected. Because some of these fields and subfields provide information that may be usable in cyberattacks against the AP 102 or the STAs 104, a malicious entity that intercepts a data packet that includes the MAC header 500 may be able extract such information even if the data packet is encrypted.

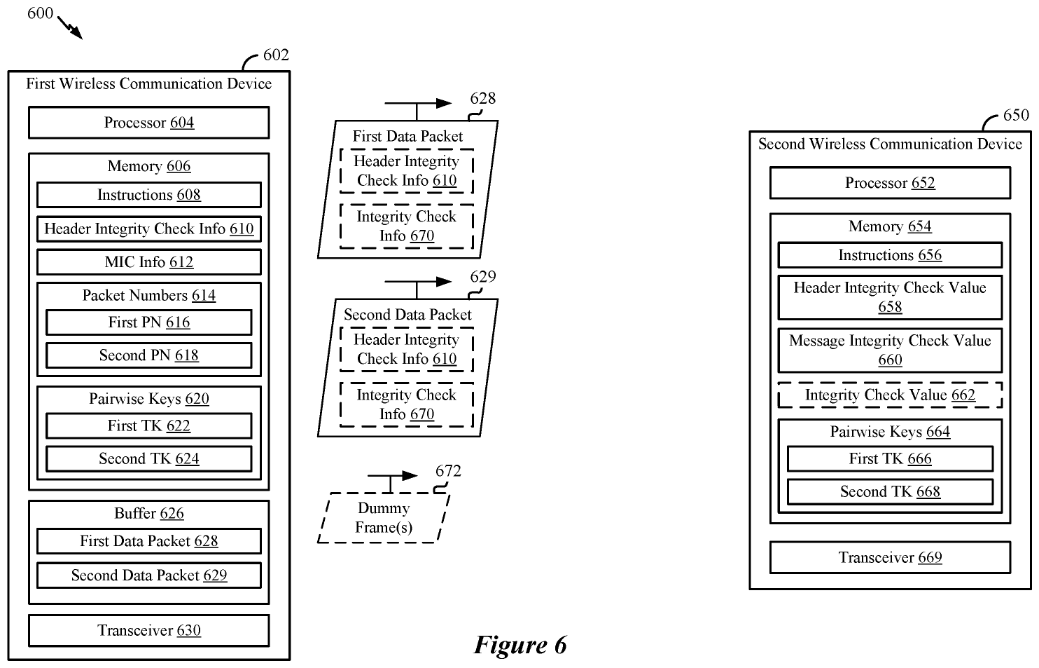

FIG. 6 shows a block diagram of an example wireless communication system 600 that supports header integrity verification according to some aspects of the present disclosure. In some examples, the wireless communication system 600 may implement aspects of the wireless communication network 100 of FIG. 1. Wireless communication system 600 may include a first wireless communication device 602 and a second wireless communication device 650. In some implementations, the first wireless communication device 602 may include or correspond to the AP 102 of FIG. 1, and the second wireless communication device 650 may include or correspond to the STA 104 of FIG. 1. In some other implementations, the first wireless communication device 602 may include or correspond to the STA 104 of FIG. 1, and the second wireless communication device 650 may include or correspond to the AP 102 of FIG. 1. Although two wireless communication device 602 and 650 are illustrate, in some other implementations, the wireless communication system 600 may generally include more than three wireless communication devices, such as multiple APs, multiple STAs, or a combination thereof.

The first wireless communication device 602 may include a variety of components (such as structural, hardware components) used for carrying out one or more functions described herein. For example, these components may include one or more processors 604 (hereinafter referred to collectively as “processor 604”), one or more memory devices 606 (hereinafter referred to collectively as “memory 606”), a buffer 626, and one or more transceivers 630 (hereinafter referred to collectively as “transceiver 630”). In some implementations, the transceiver 630 may include an interface (e.g., a communication interface) that includes a transmitter and a receiver. In some other implementations, the first wireless communication device 602 may include a transmitter, a receiver, or a combination thereof. The processor 604 may be configured to execute instructions 608 stored in the memory 606 to perform the operations described herein.

The memory 606 includes or is configured to store the instructions 608 and header integrity check information 610, MIC information 612, packet numbers 614, and pairwise keys 620. The header integrity check information 610 may be generated based on one or more fields, or subfields, of a header of a data packet, as further described herein. The MIC information 612 may be determined based on a payload of a data packet, and optionally one or more fields of a header of the data packet, as further described herein. Packet numbers 614 may include incrementable values configured to track counts of particular types of packets that have been transmitted by the first wireless communication device 602. The pairwise keys 620 may include encryption keys generated as part of encryption key pairs during association with other wireless communication devices, such as the second wireless communication device 650.

The buffer 626 is configured to temporarily store (e.g., to buffer) one or more data packets generated by, or to be processed by, the first wireless communication device 602. For example, the buffer 626 may include or correspond to a TX buffer that buffers one or more data packets to be wirelessly transmitted by the first wireless communication device 602. The buffer 626 may store data packets until the data packets are transmitted, until a particular time, until a flush operation is initiated, for a particular packet lifetime, until the buffer 626 is full, or until another trigger condition is detected.

The transceiver 630 is configured to transmit control information and data, such as one or more packets, to one or more other devices, and to receive control information and data from one or more other devices. For example, the transceiver 630 may transmit control information and data to, and may receive control information and data from, the second wireless communication device 650. In some implementations, the transceiver 630 may include or correspond to one or more components of AP 102 or STA 104 described with reference to FIG. 1.

The second wireless communication device 650 may include a variety of components (such as structural, hardware components) used for carrying out one or more functions described herein. For example, these components may include one or more processors 652 (hereinafter referred to collectively as “processor 652”), one or more memory devices 654 (hereinafter referred to collectively as “memory 654”), and one or more transceivers 669 (hereinafter referred to collectively as “transceiver 669”). In some implementations, the transceiver 669 may include an interface (e.g., a communication interface) that includes a transmitter and a receiver. In some other implementations, the second wireless communication device 650 may include a transmitter, a receiver, or a combination thereof. The processor 652 may be configured to execute instructions 656 stored in the memory 654 to perform the operations described herein.

The memory 654 includes or is configured to store instructions 656 and header integrity check value 658, message integrity check value 660, integrity check value 662, and pairwise keys 664. The header integrity check value 658 may be generated based on one or more fields, or subfields, of a header of a data packet, as further described herein. The message integrity check value 660 may be determined based on a payload of a data packet, and optionally one or more fields of a header of the data packet, as further described herein. The integrity check value 662 is optional and may be generated based on the header integrity check value 658 and the message integrity check value 660. The pairwise keys 664 may include encryption keys generated as part of encryption key pairs during association with other wireless communication devices, such as the first wireless communication device 602.

The transceiver 669 is configured to transmit control information and data to one or more other devices, and to receive reference signals, control information and data from one or more other devices. For example, the transceiver 669 may transmit control information and data to, and receive control information and data from, the first wireless communication device 602. In some implementations, the transceiver 669 may include or correspond to one or more components of AP 102 or STA 104 described with reference to FIG. 1.

During operation of the wireless communications system 600, the first wireless communication device 602 may generate one or more data packets to be transmitted to other devices, such as a first data packet 628. During a generation process and until transmission, or another time or occurrence of a triggering condition, the first data packet 628 may be stored in the buffer 626 as the first wireless communication device 602. The first data packet 628 may include a header and a payload, and optionally one or more additional fields such as a MIC information field, a frame check sequence (FCS) field, one or more other protection or error correction fields, one or more other fields, or a combination thereof. At least some of the various fields of the first data packet 628 may be populated with values at different times. For example, some fields may depend on values of other fields and therefore may not be determined until the other fields are populated. As another example, some values to be populated in some fields may take longer to process or generate than others, resulting in population of the fields at different times. The time at which the fields are populated may affect how other fields are populated. For example, at least one field of the header may not be populated with a corresponding value at a time when encryption of the data packet is initiated, according to an encryption protocol such as GCMP or CCMP, as non-limiting examples. Because the at least one field of the header is not populated with a value when the encryption is initiated, the at least one field may be “masked” during the encryption, such that the encryption does not affect, and therefore not protect, the at least one field of the header. Alternatively, the first data packet 628 may include data that is to be retransmitted (e.g., retried) due to error in receiving the data at a receiving device such as the second wireless communication device 650, and as such, the first data packet 628 may include a previously encrypted data unit such that any changes to the header of the first data packet 628 from a previously transmitted data packet are not protected by the encryption used for the previously encrypted data unit. Thus, the header of the first data packet 628 may be unprotected when the first data packet 628 is transmitted using typical packet encryption techniques.

To enable header integrity check operations (e.g., to protect one or more fields of the header) at a receiving device, the first wireless communication device 602 may generate the header integrity check information 610 based on one or more fields (or subfields) of the header for the first data packet 628. For example, the first wireless communication device 602 may apply a hash function to values contained by the one or more fields to generate the header integrity check information 610. Alternatively, other operations may be performed based on the values contained by the one or more fields to generate one or more derived values that comprise the header integrity check information 610. After generating the header integrity check information 610, the first wireless communication device 602 may the first data packet 628 or a second data packet 629 based on the header integrity check information 610, and the first wireless communication device 602 may transmit the generated packet (e.g., the first data packet 628 or the second data packet 629) to other wireless communication device(s), such as the second wireless communication device 650. Generating the first data packet 628 based on the header integrity check information 610 may include populating a field in the header of the first data packet 628 with the header integrity check information 610 or populating a field within the first data packet 628 with a value derived from the header integrity check information 610 (e.g., integrity check information 670), as further described below. Generating the second data packet 629 based on the header integrity check information 610 may include populating a field in a header of the second data packet 629 with the header integrity check information 610 or populating a field within the second data packet 629 with a value derived from the header integrity check information 610 (e.g., the integrity check information 670), where the second data packet 629 is transmitted after transmission of the first data packet 628, as further described below.

In some implementations, the one or more fields of the header used to generate the header integrity check information 610 is a single field or subfield of the header. In some other implementations, the one or more fields of the header used to generate the header integrity check information 610 includes multiple fields or subfields of the header. The one or more fields may include or correspond to one or more fields of a MAC header that is included in the header of the first data packet 628. For example, the one or more fields may include or correspond to any of the unprotected fields or subfields described above with reference to FIG. 5, such as the frame control field 502, the duration/ID field 504, at least some subfields of the sequence control field 512, at least some subfields of the QoS control subfield 516, the HT control field 518, or a combination thereof. Additionally or alternatively, the one or more fields may include or correspond to other fields within the header, such as one or more fields or subfields of an encryption header included in the header, one or more other header fields or subfields, or a combination thereof. Although described herein primarily in the context of GCMP encryption, aspects of the disclosure may be used to provide header protection for other encryption protocols, such as CCMP or the like.

The header integrity check information 610 may be distinct from the MIC information 612 for the first data packet 628. For example, the first wireless communication device 602 may generate the MIC information 612 based on a payload (e.g., one or more data units or frames) of the first data packet 628, and optionally some fields of the header (e.g., fields that are already populated and thus are not masked during encryption of the payload), such as one or more particular fields of a MAC header included in the header of the first data packet 628. In some implementations, these one or more particular fields of the MAC header are not be used to generate the header integrity check information 610. In some other implementations, at least one of these particular fields of the MAC header may be used to generate the header integrity check information 610. The payload may include data that is being encrypted as part of generation of the first data packet 628 or a previously encrypted data unit that is to be retried (e.g., retransmitted), and as such the first data packet 628 may include or correspond to a data frame or a management frame. Alternatively, the payload may include a null value (or otherwise be empty), and the first data packet 628 may include or correspond to a null frame. As a particular example, the first data packet 628 may be a QoS null frame. Although the techniques described herein apply primarily to data frames, management frames, and null frames, similar header protection may be provided for control frames. For example, a header of a control frame may include a frame control field, a duration field, and one or more address fields, and header integrity check information may be similarly generated based on one or more fields or subfields of a header of a control frame, although the signaling and other security parameters described herein may be at different locations for control frames as compared to data frames, management frames, and null frames.

The first wireless communication device 602 may generate the header integrity check information 610 after the one or more fields of the header have been populated, and new header integrity check information may be generated each time a particular MAC protocol data unit (MPDU) is transmitted. For example, the header integrity check information 610 may be generated regardless of whether it is the first time a particular MPDU in the payload of the first data packet 628 is being transmitted or if this is a retry (e.g., retransmission) of the particular MPDU, since fields in the header may change for retransmissions. The size of the header integrity check information 610 may be a fixed value that is preprogrammed at wireless devices or that is selected from one or more candidate values by negotiation, such as during an association process between the first wireless communication device 602 and the second wireless communication device 650. For example, the header integrity check information 610 may consist of 8, 16, or 32 octets, in some implementations.

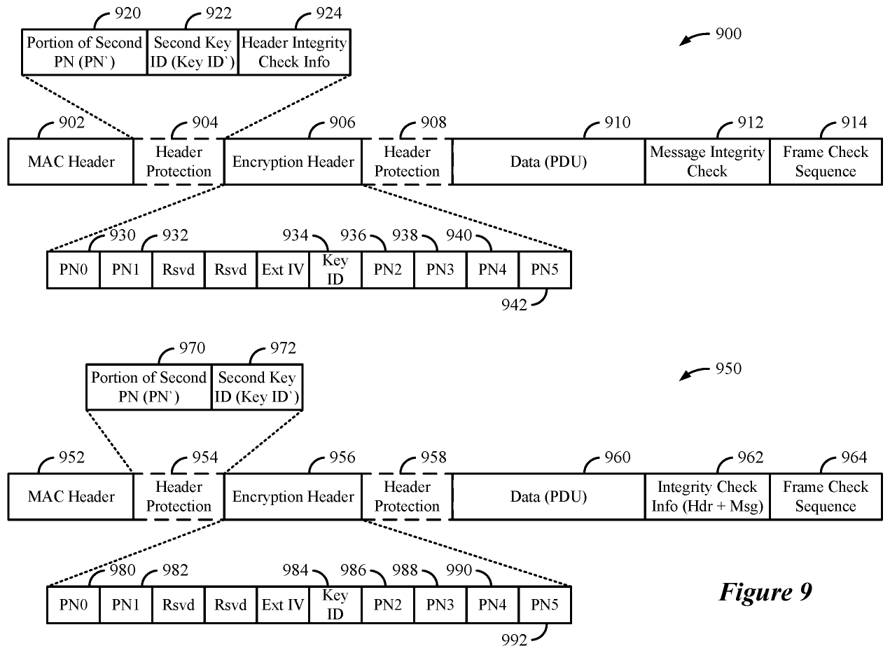

In some implementations, the first wireless communication device 602 may include hardware with enough processing resources to generate the header integrity check information 610 within the time that the fields of the first data packet 628 are populated (e.g., quick enough that the header integrity check information 610 is available when the first data packet 628 is otherwise completed and ready for transmission). In some such implementations, the first wireless communication device 602 generates the first data packet 628 based on the header integrity check information 610. To illustrate, the first wireless communication device 602 may include the header integrity check information 610 in a field of the header of the first data packet 628 or another field, or the first wireless communication device 602 may generate a value derived from the header integrity check information 610 that is included in a field of the first data packet 628 (e.g., a field after the header, or in some other implementations a field within the header). If the first wireless communication device 602 inserts the header integrity check information 610 in the header of the first data packet 628, the header may include a first subset of fields that corresponds to a MAC header and a second subset of fields that corresponds to an encryption header, and the header integrity check information 610 may be populated in a header integrity check field that is located in the header between the MAC header and the encryption header or between the encryption header and an end of the header, as further described herein with reference to FIG. 9. The header integrity check field in the header may be distinct from a MIC field within the first data packet 628. Alternatively, if the first wireless communication device 602 inserts a value derived from the header integrity check information 610 in the first data packet 628, the value may be populated in the MIC field of the first data packet 628. To further illustrate, the first wireless communication device 602 may perform one or more operations, such as an exclusive-OR (XOR) operation based on the header integrity check information 610 and the MIC information 612 to generate the integrity check information 670, and the integrity check information 670 may be populated in the MIC field of the first data packet 628. If the first data packet 628 is a null frame, the MIC information 612 may be a null value (e.g., all zeroes) such that performing the XOR operation on the header integrity check information 610 and the MIC information 612 results in the integrity check information 670 being the same as the header integrity check information 610. Thus, the first data packet 628 may include individual fields for the header integrity check information 610 (e.g., a header integrity check field containing a value based on one or more fields of the header of the first data packet 628) and the MIC information 612 (e.g., a MIC field containing a value based on the payload of the first data packet 628), or the first data packet 628 may include a single field (e.g., the MIC field) that includes the integrity check information 670 that is related to both header integrity and message integrity (e.g., the integrity check information 670 is based on the one or more fields of the header and the payload of the first data packet 628).

In some other implementations, the first wireless communication device 602 may not be able to generate the header integrity check information 610 within the time that the fields of the first data packet 628 are populated. In some such implementations, the first wireless communication device 602 generates the second data packet 629 based on the header integrity check information 610. The second data packet 629 may be a data packet that is being generated when the header integrity check information 610 is completed, and thus is to be transmitted at a later time (e.g., after transmission of the first data packet 628, and optionally one or more intervening data packets in a sequence). To illustrate, the first wireless communication device 602 may include the header integrity check information 610 in a field of a header of the second data packet 629 or another field, or the first wireless communication device 602 may generate a value derived from the header integrity check information 610 that is included in a field of the second data packet 629 (e.g., a field after the header, or in some other implementations a field within the header). For example, similar to as described above with reference to the first data packet 628, the second data packet 629 may include the header integrity check information 610, such as in a field of the header of the second data packet 629, or the integrity check information 670, such as in a MIC field of the second data packet 629. However, if the integrity check information 670 is included in the second data packet 629, the integrity check information 670 may be based on the one or more fields of the header of the first data packet 628 and a payload of the second data packet 629. In implementations in which the first wireless communication device 602 generates the second data packet 629 based on the header integrity check information 610, a receiving device (e.g., the second wireless communication device 650) buffers received data packets until a later data packet with related header integrity check information or integrity check information.

Alternatively, if the first wireless communication device 602 is not able to generate the header integrity check information 610 within the time that the fields of the first data packet 628 are populated, the first wireless communication device 602 may generate and transmit one or more dummy frames 672 until the header integrity check information 610 is generated. For example, the first wireless communication device 602 may add pre-made QoS null frames, or other dummy frames 672, to the buffer 626 in front of the first data packet 628 until the header integrity check information 610 is generated and all of the fields of the first data packet 628 are populated. A receiving device, such as the second wireless communication device 650 may discard the received dummy frames 672 until the first data packet 628 is received. In some implementations, requirements specified in one or more wireless communication standards, such as an IEEE 802.11 standard, may be relaxed for the dummy frames 672 used in this context. For example, a wireless communication standard may specify that some fields of a MAC header, such as duration, size, etc., are to carry the same value for all MPDUs within an aggregated MPDU (A-MPDU), but the values for these fields in the first data packet 628 may not be generated until later (e.g., when the header integrity check information 610 is finished). Because the dummy frames 672 are being discarded by the receiving device, the dummy frames 672 may be allowed to have different values in their MAC headers than those included in the MAC header of the first data packet 628, even if they are included in the same A-MPDU as the first data packet 628.

In some implementations, the first wireless communication device 602 may use different encryption keys, different packet numbers, or a combination thereof, to perform encryption of payloads (e.g., MPDUs) and generation of the header integrity check information 610. Stated differently, the header integrity check information 610 may be generated based on one or both of a second packet number 618 that is distinct from a first packet number 616 included in the header of the first data packet 628 (and is used to encrypt the payload of the first data packet 628) or a second encryption key (e.g., a second temporal key 624) that is distinct from a first encryption key (e.g., a first temporal key 622) used to encrypt the payload of the first data packet 628. To illustrate, the first wireless communication device 602 may maintain two or more packet numbers 614, the first packet number 616 (“first PN”) for use in encrypting payloads and the second packet number 618 (“second PN”) for generating header integrity check information. This may prevent issues, particularly for retry packets, where because an MPDU that is encrypted using an original packet number is not re-encrypted during retransmission, a retransmission that includes header integrity check information would be based on a new packet number that is unknown to the receiving device (e.g., because the new packet number is different due to one or more intervening transmitted data packets). Additionally or alternatively, using the same encryption key with different packet numbers may enable a malicious entity to reverse-engineer the encryption key or may cause issues for centralized WLAN networks in which a centralized device encrypts packets to be transmitted but provides the encrypted packets to individual APs for the wireless transmission. In such a WLAN, both the centralized device and the APs would require the same encryption key in order to perform the transmission, which may violate a security protocol of the WLAN that specifies that the encryption key is only stored by the centralized device. Aspects described herein leverage multiple packet numbers, multiple encryption keys (e.g., transitory keys (TKs)), or both, to solve these issues.

In some implementations in which two packet numbers are used, the first wireless communication device 602 maintains separate packet number spaces for packet number allocated to encryption and packet number allocated header integrity. For example, the first packet number 616 may be included in a first range of packet numbers that is allocated to payload encryption and the second packet number 618 may be included in a second range of packet numbers that is allocated to header integrity. In such implementations, the header integrity check information 610 may be generated based on the second packet number 618 and the payload of the first data packet 628 may be encrypted based on the first packet number 616, and thus the MIC information 612 may be generated based on the first packet number 616. Because the second packet number 618 is selected from a distinct range of packet numbers, the first wireless communication device 602 may signal the second packet number 618 to a receiving device, such as including the second packet number 618 in a field of the header of the first data packet 628. In some such implementations, the second packet number 618 may consist of 6 octets. Alternatively, a compressed value or other value derived from the second packet number 618 may be included in the header of the first data packet 628. As an example, the value may be the least two significant octets of the second packet number 618. Alternatively, instead of signaling the second packet number 618, the first wireless communication device 602 may use a number known to the receiving device (e.g., the second wireless communication device 650) as the second packet number 618. For example, the wireless communications devices 602 and 650 may have synchronized clocks, and as such the devices may be configured to use a timestamp (or a portion of a timestamp) associated with transmission of the first data packet 628 as the second packet number 618.

In some other implementations in which two packet numbers are used, the first wireless communication device 602 may maintain a single packet number space for both allocations (e.g., encryption and header integrity), and the first wireless communication device 602 may signal at least a portion of the second packet number 618 to a receiving device. For example, the second packet number 618 may be greater than the first packet number 616 (e.g., due to one or more intervening transmitted packets), and both the first packet number 616 and the second packet number 618 are included in a range of packet numbers that is allocated to payload encryption. In some implementations, the portion of the second packet number 618 that is signaled may consist of 2 octets, which may accommodate up to 65,000 MPDU transmissions. Alternatively, the first wireless communication device 602 may be configured to select the first packet number 616 from a first subset of the packet number space, and the first wireless communication device 602 may be configured to select the second packet number 618 from a second subset of the same packet number space. As non-limiting examples, even packet numbers (e.g., the first subset) may be allocated to encryption and odd packet numbers (e.g., the second subset) may be allocated to header integrity, or every j packet numbers (e.g., the second subset) may be allocated to header integrity and the remaining packet numbers (e.g., the first subset) may be allocated to encryption. Other schemes for dividing the packet number space are also possible, based on design considerations. In some such implementations, the second packet number 618, or a portion thereof or a value derived therefrom, may be included in the header of the first data packet 628. For example, 8 octets of the second packet number 618, or the least two significant octets of the second packet number 618, may be included in the header of the first data packet 628. Alternatively, the first wireless communication device 602 may embed an indication of the second packet number 618 in the header of the first data packet 628. For example, if every 8 packet numbers are used for encryption, the header of the first data packet 628 may include an index within the remaining 7 packet numbers that corresponds to the second packet number 618, or the header may include a number of retries corresponding to the MPDU included in the first data packet 628, or another type of indicator that enables a receiving device (e.g., the second wireless communication device 650) to determine the second packet number 618.

In some implementations in which two encryption keys are used, the first wireless communication device 602 may generate the multiple pairwise keys 620 that include the first temporal key 622 and the second temporal key 624. For example, during association between the first wireless communication device 602 and the second wireless communication device 650, the first wireless communication device 602 may generate the first temporal key 622 and the second temporal key 624, and the second wireless communication device 650 may generate a first temporal key 666 of the pairwise keys 664 and a second temporal key 668 of the pairwise keys 664. As such, the pairwise keys 620 and the pairwise keys 664 may form two pairs of pairwise encryptions keys: a first pair (e.g., the first temporal key 622 and the first temporal key 666) and a second pair (e.g., the second temporal key 624 and the second temporal key 668). The first wireless communication device 602 may encrypt payloads of data packets, such as the payload of the first data packet 628, based on the first temporal key 622, and the first wireless communication device 602 may generate the header integrity check information 610 based on the second temporal key 624. Similarly, the second wireless communication device 650 may decrypt a payload of a received data packet based on the first temporal key 666, and the second wireless communication device 650 may generate the header integrity check value 658 based on the second temporal key 668. The pairwise keys 620 and 664 may also be used to decrypt received packets at the first wireless communication device 602 and to encrypt payloads at the second wireless communication device 650, respectively. Additionally or alternatively, the second temporal key 624 and the second temporal key 668 may be used for control frame protection in a similar manner as to the generation of header integrity check information. In some implementations, additional encryption keys may be leveraged to extend the header protections described herein to group-addressed messages. For example, additional pairwise keys may be generated by the wireless communication devices 602 and 650 during association or formation of a group. The additional pairwise keys may include a respective group temporal key for encrypting group messages and a respective group temporal key for generating group message header integrity check information. Additional packet numbers for group transmissions may similarly be maintained. In some other implementations, the wireless communication devices 602 and 650 may use a single encryption key (e.g., the first temporal key 622 and the first temporal key 666, respectively) to encrypt data and to generate header integrity check information, although such implementations may include additional security protections or may not be implemented by centralized WLANs where the single encryption key is stored at a centralized controller but wireless transmission is distributed among multiple APs.

In some implementations in which two packet numbers, two encryption keys, or both, are used, the first wireless communication device 602 may include at least a portion of the second packet number 618, an identifier (e.g., an encryption key identifier) corresponding to the second temporal key 624, or both, in the header of the first data packet 628. For example, the header may include a first subset of fields that corresponds to a MAC header, a second subset of fields that corresponds to an encryption header, and a header integrity field, and the header integrity field (or subfield(s) thereof) may include at least a portion of the second packet number 618. Alternatively, the header integrity field (or subfield(s)) thereof) may include at least a portion of the second packet number 618 and an encryption key identifier that corresponds to the second temporal key 624. The header integrity field may be located between the MAC header and the encryption header or after the encryption header in the header of the first data packet 628, as further described herein with reference to FIG. 9.

After transmission of the first data packet 628 or the second data packet 629, the second wireless communication device 650 may receive the first data packet 628, and in some implementations the second data packet 629, and the second wireless communication device 650 may perform a header integrity check operation based on one or more fields of the header of the first data packet 628 or one or more fields of the second data packet 629. For example, if the first data packet 628 includes the header integrity check information 610, the second wireless communication device 650 may generate the header integrity check value 658 based on one or more fields of the header of the first data packet 628, and the second wireless communication device 650 may compare the header integrity check information 610 to the header integrity check value 658 to determine if a match occurs. The one or more fields of the header used by the second wireless communication device 650 to generate the header integrity check value 658 may be the same as the one or more fields of the header used by the first wireless communication device 602 to generate the header integrity check information 610, such that a match indicates that the one or more fields have not been altered since generation of the header integrity check information 610 by the first wireless communication device 602. The second wireless communication device 650 may apply the same hash function or perform the same operations on the one or more headers of the first data packet 628 to generate the header integrity check value 658 as the hash function or operations performed by the first wireless communication device 602 to generate the header integrity check information 610. In some such implementations, the second wireless communication device 650 may generate the message integrity check value 660 based on the payload on the payload of the first data packet 628 received by the second wireless communication device 650, and option based on field(s) of the header, and the second wireless communication device 650 may compare the message integrity check value 660 to the MIC information 612 included in the first data packet 628 to determine if there is a match.

As another example, if the first data packet 628 includes the integrity check information 670 (and the integrity check information 670 corresponds to header integrity and message integrity), the header integrity check value 658 may be generated based on one or more fields of the header of the first data packet 628 and the message integrity check value 660 may be generated based on the payload of the first data packet 628. The second wireless communication device 650 may generate the integrity check value 662 based on the header integrity check value 658 and the message integrity check value 660, and the second wireless communication device 650 may compare the integrity check information 670 to the integrity check value 662 to determine if there is a match. In some such implementations, generating the integrity check value 662 may include performing a XOR operation, or other operation(s), based on the header integrity check value 658 and the message integrity check value 660.

If the header integrity check information 610 is included in the header of the second data packet 629, the second wireless communication device 650 may perform the header integrity check based on the one or more fields of the header of the first data packet 628 to generate the header integrity check value 658 that is compared to the header integrity check information 610 included in the second data packet 629. Alternatively, if the integrity check information 670 is included in the header of the second data packet 629, the second wireless communication device 650 may generate the header integrity check value 658 based on the one or more fields of the header of the first data packet 628, and the second wireless communication device 650 may generate the message integrity check value 660 based on the payload of the second data packet 629. If the second wireless communication device receives the dummy frames 672 prior to the first data packet 628, the second wireless communication device may discard the dummy frames 672 upon receipt of the first data packet 628.

If the header integrity check is successful (e.g., if the header integrity check value 658 matches the header integrity check information 610 or if the integrity check value 662 matches the integrity check information 670), the second wireless communication device 650 may process the header of the first data packet 628. The second wireless communication device 650 may process the header even if a message integrity check fails (e.g., the message integrity check value 660 does not match the MIC information 612). However, if the header integrity check fails (e.g., if the header integrity check value 658 does not match the header integrity check information 610 or if the integrity check value 662 does not match the integrity check information 670), the second wireless communication device 650 may discard the first data packet 628 without processing the header of the first data packet 628 (or any other portions).

In some implementations, one or more particular fields or subfields of a header, particularly a MAC header, that are typically masked out during encryption may be protected. For example, a sequence number that is stored in the sequence number subfield 552 of FIG. 5 may be populated prior to encryption of a payload of the first data packet 628 (e.g., using the first packet number 616 and the first temporal key 622), thereby protecting a sequence number. This may be done with minimal changes to existing WLAN configurations, because the sequence number is typically assigned early on in the packet generation process and remains the same for retransmissions. As another example, the presence of the HT control field 518 of FIG. 5 may be mandated, and as such, the +HTC subfield 540 of FIG. 5 may be populated (e.g., with a fixed value since the HT control field 518 will always be present) prior to encryption and thereby be protected by encryption of payload of the first data packet 628. Because the value is fixed, there is no need to mask it during encryption, and mandating the presence of the HT control field 518 makes the size of the header more deterministic. Additional examples of the one or more particular fields of the MAC header include the TID subfield of the QoS control field 516.

Additionally, or alternatively, concepts described herein with reference to generation of header integrity check information may be extended to encrypting one or more particular fields of a header, such as one or more fields of a MAC header. To illustrate, the first wireless communication device 602 may maintain an additional packet number and an additional temporal key (not shown) used for encrypting fields of the header, and these additional keys may be used to encrypt one or more fields of the header of the first data packet 628 prior to transmission of the first data packet 628. For example, at least some subfields of the frame control field 502, the duration/ID field 504, at least some subfields of the sequence control field 512, at least some subfields of the QoS control subfield 516, the HT control field 518, or a combination thereof, may be encrypted based on the additional packet number and the additional temporal key. The encryption performed on the fields of the header of the first data packet 628 may be use the same encryption protocol as the encryption performed on the payload of the first data packet 628, such as GCMP or CCMP, or the encryption performed on the fields of the header of the first data packet 628 may use a different encryption protocol. Similar to as described above for enabling header integrity checks, the additional packet number (or a portion thereof) and an additional key ID that corresponds to the additional temporal key may be signaled by the first wireless communication device 602, such as by including the portion of the additional packet number (or an indication thereof) and the additional key ID in the header of the first data packet 628 or the header of the second data packet 629. The second wireless communication device 650 (e.g., a receiving device) may decrypt the encrypted fields using the additional packet number and the additional temporal key indicated by the additional key ID. In some implementations, the additional packet number may be determined based on a time stamp associated with transmission of the first data packet 628 (e.g., using a timing synchronization function (TSF)), similar to as described above. This separate encryption of field(s) of the header may be used in place of or in combination with the above-described header integrity check techniques. For example, if the separate encryption is used without header integrity checks, one or more particular fields of the header of the first data packet 628 may be encrypted using the additional packet number and the additional temporal key to protect the one or more particular fields of the header. In this example, one or more other fields of the header may already be protected by being used to generate the AAD used to encrypt the payload of the first data packet 628. As another example, a first subset of fields of the header of the first data packet 628, the second packet number 618, and the second temporal key 624 may be used to generate the header integrity check information 610 to protect the first subset of fields, and a second subset of fields of the header may be encrypted based on the additional packet number and the additional temporal key to protect the second subset of fields. In this example, a portion of the second packet number 618, a key ID that corresponds to the second temporal key 624, a portion of the additional packet number, and a key ID that corresponds to the additional temporal key may be included in the header of the first data packet 628 or the header of the second data packet 629 to enable both a header integrity check operation and decryption at the second wireless communication device 650.

As described above with reference to FIG. 6, the wireless communications system 600 may support header protection for wirelessly communicated packets. In some examples, by including header integrity check information 610 in the first data packet 628 or the second data packet 629, the wireless communications system 600 enables performance of header integrity check operations at a receiving device (e.g., the second wireless communication device 650). For example, the second wireless communication device 650 may generate its own header integrity check information (e.g., the header integrity check value 658 or the integrity check value 662) based on one or more fields of the header of the first data packet 628, and if the header integrity check value 658 fails to match the header integrity check information 610 included in the first data packet 628 or the second data packet 629 (or the integrity check value 662 fails to match the integrity check information 670), the second wireless communication device 650 may refrain from processing the header of the first data packet 628. By refraining from processing headers for which the integrity is not verified, the second wireless communication device 650 may avoid processing headers of packets that were generated by a malicious entity that intercepted the data packets sent by the first wireless communication device 602 and that altered one or more fields of the header to perform a cyber attack on the second wireless communication device 650. For example, the second wireless communication device 650 may refrain from processing a MAC header that has been modified to trigger the second wireless communication device 650 to change a value of a counter or another state that may be used for a denial of service attack or to negatively affect the power state of the second wireless communication device 650. The header integrity check information 610 may be added to the header or another field of a data packet (e.g., the first data packet 628 or the second data packet 629) to provide for this improved protection capability with minimal increase to network overhead, thereby preventing wireless communication devices from being targeted by certain cyberattacks without significantly increasing latency or congestion in a wireless network.

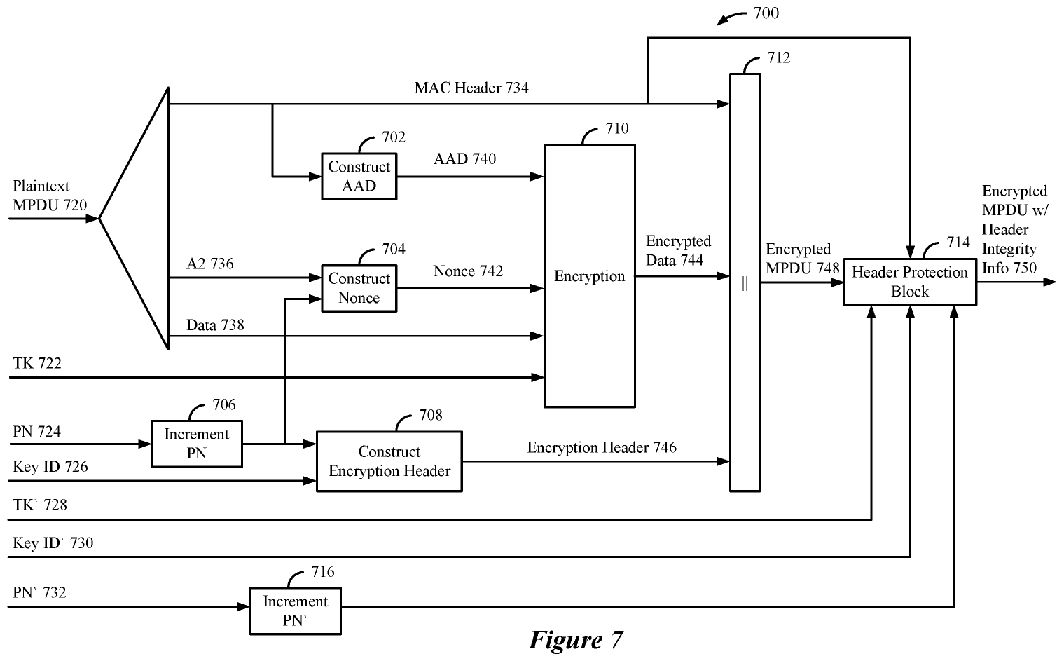

FIG. 7 shows a block diagram of an example system architecture 700 that is configured to generate an encrypted MPDU with header integrity check information according to some aspects of the present disclosure. The system architecture 700 may be used to protect one or more fields of a header of a data frame or a management frame. In some implementations, the system architecture 700 may be included in or implemented by the first wireless communication device 602 or the second wireless communication device 650 of FIG. 6. As shown in FIG. 7, the system architecture 700 may include an AAD construction unit 702, a nonce construction unit 704, a first packet number incrementor 706, an encryption header construction unit 708, an encryption unit 710, a combiner 712, a header protection block 714, and a second packet number incrementor 716. The system architecture 700 may receive one or more inputs, including a plaintext MPDU 720, a first temporal key 722 (“TK”), a first packet number 724 (“PN”), a first key ID 726 that corresponds to the first temporal key 722, a second temporal key 728 (“TK′”), a second key ID 730 that corresponds to the second temporal key 728, and a second packet number 732 (“PN′”). In some implementations, the first temporal key 722, the first packet number 724, the second temporal key 728, and the second packet number 732 may correspond to the first temporal key 622, the first packet number 616, the second temporal key 624, and the second packet number 618 of FIG. 6, respectively.

During operation, the plaintext MPDU 720 may be segmented into a MAC header 734, a particular address field 736 (“A2”), and data 738 (e.g., a data unit). The MAC header 734 may be provided to the AAD construction unit 702 to generate AAD 740. The particular address field 736 and the first packet number 724, after being incremented by the first packet number incrementor 706, may be provided to the nonce construction unit 704 to generate nonce 742. The AAD 740, the nonce 742, the data 738, and the first temporal key 722 may be provided to the encryption unit 710 to generate encrypted data 744. For example, the encryption unit 710 may encrypt the data 744 and related information (e.g., the AAD 740 and the nonce 742) according to an encryption protocol, such as GCMP. Because the AAD is an input to the encryption unit 710, the fields of the MAC header 734 that are used to generate the AAD 740 may be protected by the encryption performed by the encryption unit 710. However, one or more fields or subfields of the MAC header 734 may not be populated at this time, and therefore may not be protected. The first key ID 726 and the first packet number 724, after being incremented by the first packet number incrementor 706, may be provided to the encryption header construction unit 708 to generate an encryption header 746. The MAC header 734, the encrypted data 744, and the encryption header 746 may be provided as input to the combiner 712 to generate an encrypted MPDU 748. For example, the combiner 712 may include the encrypted data 744 in a payload of a data packet with a header formed by combining the MAC header 734 and the encryption header 746. The MAC header 734, the encrypted MPDU 748, the second temporal key 728, the second key ID 730, and the second packet number 732, after being incremented by the second packet number incrementor 716, may be provided to the header protection block 714 to generate encrypted MPDU with header integrity check information 750, which may include or correspond to the first data packet 628 of FIG. 6. For example, the header protection block 714 may be configured to generate the header integrity check information 610 of FIG. 6 for inclusion in the header of the encrypted MPDU 748. Alternatively, the header protection block 714 may be configured to generate the integrity check information 670 of FIG. 6 for inclusion in the MIC field of the encrypted MPDU 748. In other implementations, instead of generating header integrity check information, the header protection block 714 may encrypt one or more fields of the header based on the second temporal key 728 and the second packet number 732.

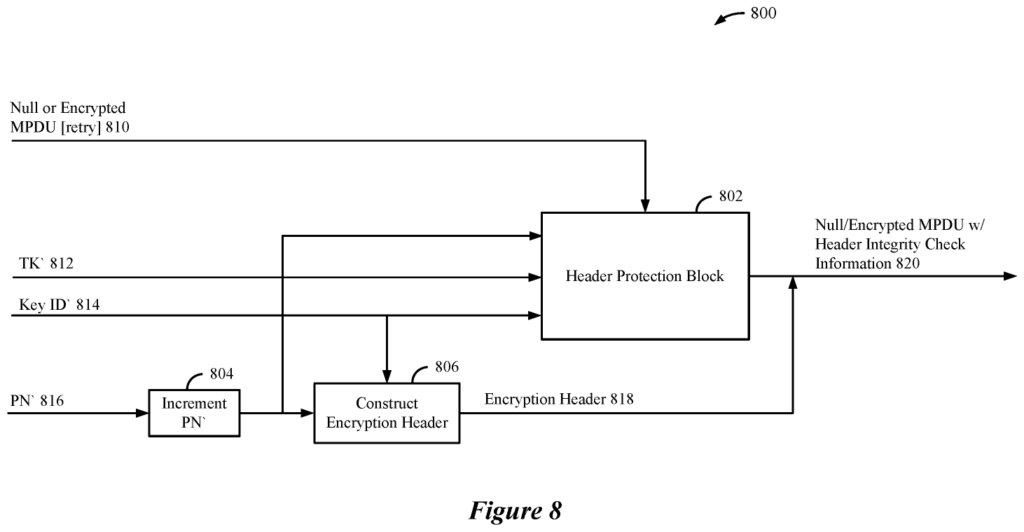

FIG. 8 shows a block diagram of an example system architecture 800 that is configured to generate header integrity check information for use with a null frame or an encrypted MPDU to be retransmitted according to some aspects of the present disclosure. In some implementations, the system architecture 800 may be included in or implemented by the first wireless communication device 602 or the second wireless communication device 650 of FIG. 6. As shown in FIG. 8, the system architecture 800 may include a header protection block 802, a packet number incrementor 804, and an encryption header construction unit 806. The system architecture 800 may receive one or more inputs, including a null/encrypted MPDU 810, a second temporal key 812 (“TK′”), a second key ID 814 that corresponds to the second temporal key 812, and a second packet number 816 (“PN′”) The null/encrypted MPDU 810 may include a null frame, such as a QoS null frame, or a previously encrypted MPDU. If the null/encrypted MPDU 810 includes an encrypted MPDU, the MPDU is a retry (e.g., retransmission) of a previously transmitted MPDU that was encrypted based on a first temporal key and a first packet number. In some implementations, the first temporal key, the first packet number, the second temporal key 812, and the second packet number 816 may correspond to the first temporal key 622, the first packet number 616, the second temporal key 624, and the second packet number 618 of FIG. 6, respectively.

During operation, the null/encrypted MPDU 810, the second temporal key 812, the second key ID 814, and the second packet number 816, after being incremented by the packet number incrementor 804, may be provided to the header protection block 802 to generate null/encrypted MPDU with header integrity check information 820, which may include or correspond to the first data packet 628 of FIG. 6. For example, the header protection block 802 may be configured to generate the header integrity check information 610 of FIG. 6 for inclusion in the header of the null/encrypted MPDU 810. Alternatively, the header protection block 802 may be configured to generate the integrity check information 670 of FIG. 6 for inclusion in the MIC field of the null/encrypted MPDU 810. In other implementations, instead of generating header integrity check information, the header protection block 802 may encrypt one or more fields of the header based on the second temporal key 812 and the second packet number 816. The second key ID 814 and the second packet number 816, after being incremented by the packet number incrementor 804, may be provided to the encryption header construction unit 806 to generate an encryption header 818 to be included in the null/encrypted MPDU with header integrity check information 820.

FIG. 9 shows example data packets that support header integrity verification according to some aspects of the present disclosure. The illustrative data packets include a first data packet 900 and a second data packet 950. The first data packet 900 corresponds to implementations in which header integrity check information is included in a header of a data packet, and the second data packet 950 corresponds to implementations in which integrity check information (e.g., based on header integrity check information and MIC information) is included in a field of a data packet.

As shown in FIG. 9, the first data packet 900 includes a MAC header 902, an first header protection field 904, an encryption header 906, a second header protection field 908, data 910 (e.g., a PDU), a MIC field 912, and a frame check sequence (FCS) field 914. In some implementations, the first data packet 900 includes the first header protection field 904 or the second header protection field 908, but not both. In other implementations, the first data packet 900 may include both the first header protection field 904 and the second header protection field 908, and information described as being included in one field may be split across the two header protection fields 904, 908 or duplicated between the two header protection fields 904, 908.

If the first data packet 900 includes the first header protection field 904, the first header protection field 904 may include a portion of a second packet number 920, a second key ID 922, and header integrity check information 924. The portion of the second packet number 920 may include one or more octets, or other sized portions, of a second packet number that is used to generate the header integrity check information 924, and the second key ID 922 may correspond to a second temporal key that is used to generate the header integrity check information 924. In some implementations, the header integrity check information 924 may include or correspond to the header integrity check information 610 of FIG. 6. If the first data packet 900 includes the second header protection field 908, the second header protection field 908 may include the portion of the second packet number 920, the second key ID 922, and the header integrity check information 924. The encryption header 906 may include subfields related to information used to encrypt the data 910. For example, the encryption header 906 may include a first packet number subfield 930 (“PN0”), a second packet number subfield 932 (“PN1”), one or more reserved subfields, a first key ID 934, a third packet number subfield 936 (“PN2”), a fourth packet number subfield 938 (“PN3”), a fifth packet number subfield 940 (“PN4”), and a sixth packet number subfield 942 (“PN5”). The packet number subfields 930, 932, 936, 938, 940, and 942 may store a first packet number used to encrypt the data 910, and the first key ID 934 may correspond to a first temporal key that is used to encrypt the data 910. In some implementations, the MIC field 912 may include or correspond to the MIC information 612 of FIG. 6.

As shown in FIG. 9, the second data packet 950 includes a MAC header 952, an first header protection field 954, an encryption header 956, a second header protection field 958, data 960 (e.g., a PDU), an integrity check information field 962, and a FCS field 964. In some implementations, the second data packet 950 includes the first header protection field 954 or the second header protection field 958, but not both. In other implementations, the second data packet 950 may include both the first header protection field 954 and the second header protection field 958, and information described as being included in one field may be split across the two header protection fields 954, 958 or duplicated between the two header protection fields 954, 958.

If the second data packet 950 includes the first header protection field 954, the first header protection field 954 may include a portion of a second packet number 970 and a second key ID 972. The portion of the second packet number 970 may include one or more octets, or other sized portions, of a second packet number that is used to generate header integrity check information for use in populating the integrity check information field 962, and the second key ID 972 may correspond to a second temporal key that is used to generate the header integrity check information. If the second data packet 950 includes the second header protection field 958, the second header protection field 958 may include the portion of the second packet number 970 and the second key ID 972. The encryption header 956 may include subfields related to information used to encrypt the data 960. For example, the encryption header 956 may include a first packet number subfield 980 (“PN0”), a second packet number subfield 982 (“PN1”), one or more reserved subfields, a first key ID 984, a third packet number subfield 986 (“PN2”), a fourth packet number subfield 988 (“PN3”), a fifth packet number subfield 990 (“PN4”), and a sixth packet number subfield 992 (“PN5”). The packet number subfields 980, 982, 986, 988, 990, and 992 may store a first packet number used to encrypt the data 960, and the first key ID 984 may correspond to a first temporal key that is used to encrypt the data 960. The integrity check information field 962 may include integrity check information that is generated based on header integrity check information (that corresponds to the MAC header 952) and MIC information (that corresponds to the data 960). For example, an XOR operation may be performed on the header integrity check information and the MIC information to generate the value stored in the integrity check information field 962. In some implementations, the integrity check information field 962 may include or correspond to the integrity check information 670 of FIG. 6.

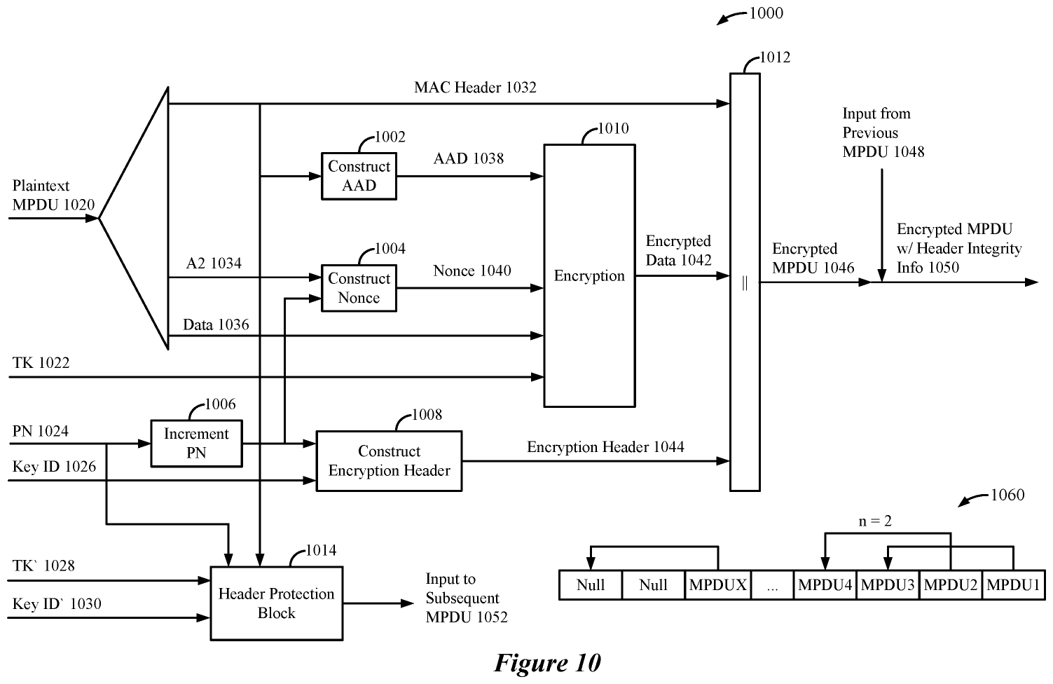

FIG. 10 shows a block diagram of another example system architecture 1000 that is configured to generate an encrypted MPDU with header integrity check information according to some aspects of the present disclosure. The system architecture 1000 may be used to protect one or more fields of a header of a data frame or a management frame by including header integrity check information (a value based thereon) in a subsequently transmitted data packet. In some implementations, the system architecture 1000 may be included in or implemented by the first wireless communication device 602 or the second wireless communication device 650 of FIG. 6. As shown in FIG. 10, the system architecture 1000 may include an AAD construction unit 1002, a nonce construction unit 1004, a packet number incrementor 1006, an encryption header construction unit 1008, an encryption unit 1010, a combiner 1012, and a header protection block 1014. The system architecture 1000 may receive one or more inputs, including a plaintext MPDU 1020, a first temporal key 1022 (“TK”), a first packet number 1024 (“PN”), a first key ID 1026 that corresponds to the first temporal key 1022, a second temporal key 1028 (“TK′”), and a second key ID 1030 that corresponds to the second temporal key 1028. In some implementations, the first temporal key 1022, the first packet number 1024, and the second temporal key 1028, may correspond to the first temporal key 622, the first packet number 616, and the second temporal key 624 of FIG. 6, respectively.

During operation, the plaintext MPDU 1020 may be segmented into a MAC header 1032, a particular address field 1034 (“A2”), and data 736 (e.g., a data unit). The MAC header 1032 may be provided to the AAD construction unit 1002 to generate AAD 1038. The particular address field 1034 and the first packet number 1024, after being incremented by the packet number incrementor 1006, may be provided to the nonce construction unit 1004 to generate nonce 1040. The AAD 1038, the nonce 1040, the data 1036, and the first temporal key 1022 may be provided to the encryption unit 1010 to generate encrypted data 1042. For example, the encryption unit 1010 may encrypt the data 1036 and related information (e.g., the AAD 1038 and the nonce 1040) according to an encryption protocol, such as GCMP. Because the AAD 1038 is an input to the encryption unit 1010, the fields of the MAC header 1032 that are used to generate the AAD 1038 may be protected by the encryption performed by the encryption unit 1010. However, one or more fields or subfields of the MAC header 1032 may not be populated at this time, and therefore may not be protected. The first key ID 1026 and the first packet number 1024, after being incremented by the packet number incrementor 1006, may be provided to the encryption header construction unit 1008 to generate an encryption header 1044. The MAC header 1032, the encrypted data 1042, and the encryption header 1044 may be provided as input to the combiner 1012 to generate an encrypted MPDU 1046. For example, the combiner 1012 may include the encrypted data 1042 in a payload of a data packet with a header formed by combining the MAC header 1032 and the encryption header 1044. The encrypted MPDU 1046 may be combined with an input from a previous MPDU 1048 to generate an encrypted MPDU with header integrity check information, which may include or correspond to the first data packet 628 of FIG. 6. For example, header integrity check information (or a value derived therefrom) for a previously transmitted data packet may be inserted in the encrypted MPDU 1046 to generate the encrypted MPDU with header integrity check information. Additionally, the MAC header 1032, the first packet number 1024, the second temporal key 1028, and the second key ID 1030 may be provided to the header protection block 1014 to generate an input for a subsequent MPDU 1052, which may include or correspond to the second data packet 629 of FIG. 6. For example, the header protection block 1014 may be configured to generate the header integrity check information 610 of FIG. 6 for inclusion in the header of the subsequent MPDU 1052. Alternatively, the header protection block 1014 may be configured to generate the integrity check information 670 of FIG. 6 for inclusion in the MIC field of the subsequent MPDU 1052. However, in the implementation shown in FIG. 10, the header protection generation takes a longer time than generation of the rest of the data packet, and thus the header integrity check information (or a value derived therefrom) is included in the subsequent MPDU 1052. In other implementations, instead of generating header integrity check information, the header protection block 1014 may encrypt one or more fields of the header based on the second temporal key 1028 and the first packet number 1024.

In some implementations, the subsequent MPDU 1052 is an nth subsequent MPDU from the plaintext MPDU 1020. For example, if n is one, the subsequent MPDU 1052 is the immediately subsequent MPDU from the plaintext MPDU 1020 in a sequence. As another example, if n is two, the subsequent MPDU 1052 and the plaintext MPDU 1020 may be separated by an intervening MPDU in the transmission sequence. In some such implementations, header protection field(s) (e.g., corresponding to the first header protection field 904, the second header protection field 908, the first header protection field 954, or the second header protection field 958 of FIG. 9) in the first n MPDU(s) are reserved or are set to a fixed value, such as all 1s or all 0s. Additionally or alternatively, an A-MPDU may end with n null frames, such as QoS null frames or other dummy frames, that include header protection field(s) that contain values that correspond to the previous n MPDUs. To illustrate, FIG. 10 illustrates an A-MPDU 1060 generated by the system architecture 1000 for which the value of n is two. As can be seen in FIG. 10, an output of the header protection block 1014 for a first MPDU (“MPDU1”) is included in a header of a third MPDU (“MPDU3”), an output of the header protection block 1014 for a second MPDU (“MPDU2”) is included in a header of a fourth MPDU (“MPDU4”), the A-MPDU 1060 includes two null frames at the end, an output of the header protection block 1014 for a second-to-last MPDU (MPDUX-1, not shown) is included in a header of a first null frame, and an output of the header protection block 1014 for a last MPDU (“MPDUX”) is included in a header of a second null frame. In some implementations, n may be preconfigured at the wireless communication devices (e.g., the first wireless communication device 602 and the second wireless communication device 650), n may be negotiated such as during an association process, n may be specified in a wireless communication standard, or n may be determined in some other manner.

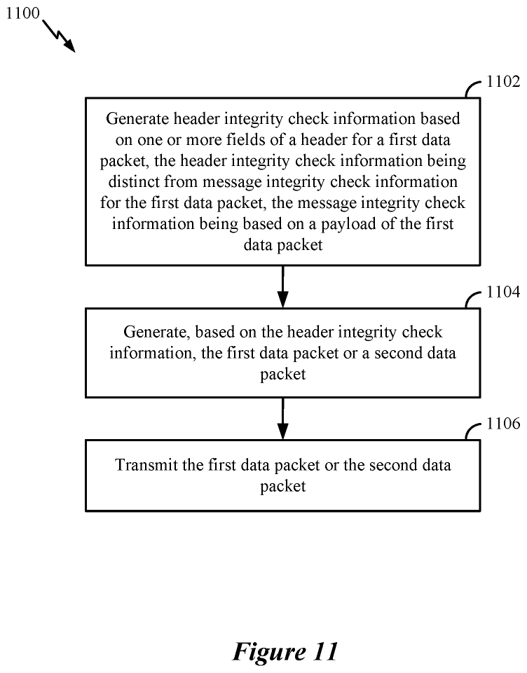

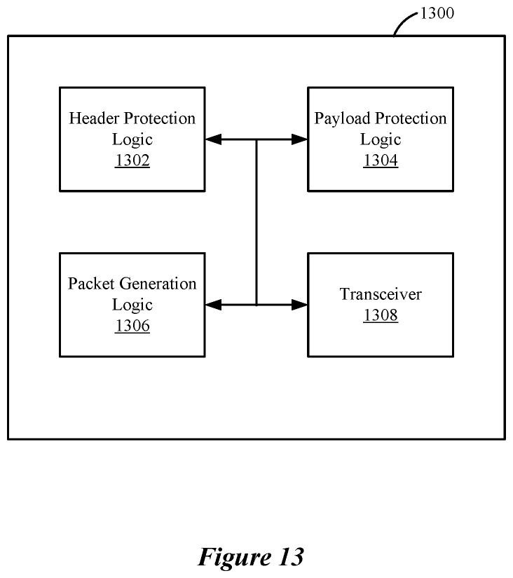

FIG. 11 shows a flowchart illustrating an example process 1100 performable at a wireless communication device that supports header integrity verification according to some aspects of the present disclosure. The operations of the process 1100 may be implemented by a wireless AP, a wireless STA, or components thereof, as described herein. For example, the process 1100 may be performed by a wireless communication device, such as the first wireless communication device 602 of FIG. 6 or the wireless communication device 1300 described with reference to FIG. 13, operating as or within a wireless AP or a wireless STA. In some examples, the process 1100 may be performed by a wireless AP such as one of the APs 102 described with reference to FIG. 1, or a wireless STA such as one of the 104 described with reference to FIG. 1.

In some examples, in block 1102, the wireless communication device generates header integrity check information based on one or more fields of a header for a first data packet. The header integrity check information is distinct from message integrity check information for the first data packet, and the message integrity check information is based on a payload of the first data packet. For example, the header integrity check information may include or correspond to the header integrity check information 610 of FIG. 6, and the message integrity check information may include or correspond to the MIC information 612 of FIG. 6.

In some examples, in block 1104, the wireless communication device generates, based on the header integrity check information, the first data packet or a second data packet. For example, the first data packet may include or correspond to the first data packet 628 of FIG. 6, and the second data packet may include or correspond to the second data packet 629 of FIG. 6.

In some examples, in block 1106, the wireless communication device transmits the first data packet or the second data packet. For example, in implementations in which the first wireless communication device 602 of FIG. 6 generates the first data packet 628 based on the header integrity check information 610, the first wireless communication device 602 transmits the first data packet 628. In other implementations in which the first wireless communication device 602 of FIG. 6 generates the second data packet 629 based on the header integrity check information 610, the first wireless communication device 602 transmits the second data packet 629.

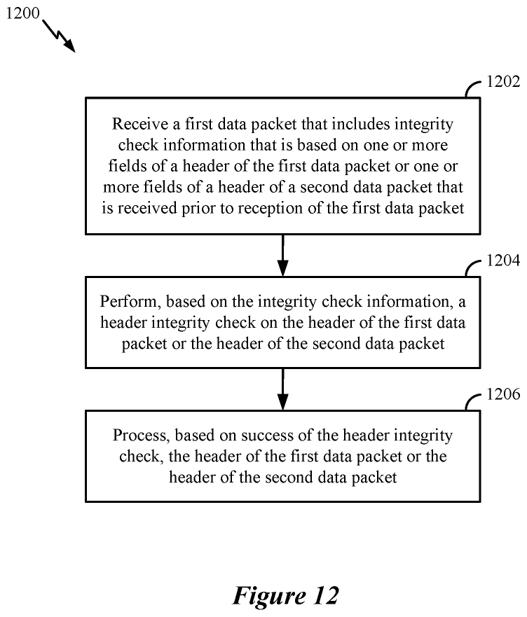

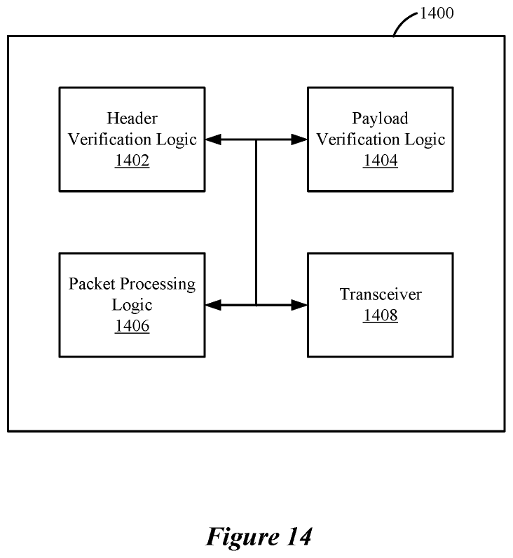

FIG. 12 shows a flowchart illustrating an example process 1200 performable at a wireless STA that supports header integrity information according to some aspects of the present disclosure. The operations of the process 1200 may be implemented by a wireless STA, a wireless AP, or components thereof, as described herein. For example, the process 1200 may be performed by a wireless communication device, such as the second wireless communication device 650 of FIG. 6 or the wireless communication device 1400 described with reference to FIG. 14, operating as or within a wireless STA or a wireless AP. In some examples, the process 1200 may be performed by a wireless STA such as one of the STAs 104 described with reference to FIG. 1 or a wireless AP such as one of the APs 102 described with reference to FIG. 1.

In some examples, in block 1202, the wireless communication device receives a first data packet that includes integrity check information that is based on one or more fields of a header of the first data packet or one or more fields of a header of a second data packet that is received prior to reception of the first data packet. For example, the integrity check information may include or correspond to the header integrity check information 610 of FIG. 6 or the integrity check information 670 of FIG. 6, the first data packet may include or correspond to the second data packet 629 of FIG. 6, and the second data packet may include or correspond to the first data packet 628 of FIG. 6.

In some examples, in block 1204, the wireless communication device performs, based on the integrity check information, a header integrity check on the header of the first data packet or the header of the second data packet. For example, the second wireless communication device 650 of FIG. 6 may perform a header integrity check on the received data packet to generate at least the header integrity check value 658.

In some examples, in block 1206, the wireless communication device processing, based on success of the header integrity check, the header of the first data packet or the header of the second data packet. For example, the second wireless communication device 650 of FIG. 6 may process the header of the received data packet (e.g., the first data packet 628 or the second data packet 629) when the header integrity check is successful.

FIG. 13 shows a block diagram of an example wireless communication device 1300 that supports header integrity verification according to some aspects of the present disclosure. In some examples, the wireless communication device 1300 is configured or operable to perform the process 1100 described with reference to FIG. 11. In various examples, the wireless communication device 1300 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1300 can be a device for use in an AP, such as AP 102 described with reference to FIG. 1, or in a STA, such as STA 104 described with reference to FIG. 1. In some other examples, the wireless communication device 1300 can be an AP or a STA that includes such a chip, SoC, chipset, package or device as well as multiple antennas. The wireless communication device 1300 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1300 also includes or can be coupled with an application processor which may be further coupled with another memory. In some examples, the wireless communication device 1300 further includes at least one external network interface that enables communication with a core network or backhaul network to gain access to external networks including the Internet.

The wireless communication device 1300 includes header protection logic 1302, payload protection logic 1304, packet generation logic 1306, and a transceiver 1308. Portions of one or more of the components 1302, 1304, 1306, and 1308 may be implemented at least in part in hardware or firmware. For example, the transceiver 1308 may include or correspond to a transmitter, a receiver, or a combination of a transmitter and a receiver (e.g., a transceiver). In some examples, at least some of the components 1302, 1304, 1306, and 1308 are implemented at least in part by a processor and as software stored in a memory. For example, portions of one or more of the components 1302, 1304, or 1306 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 1300). For example, a processing system of the wireless communication device 1300 may refer to a system including the various other components or subcomponents of the wireless communication device 1300, such as the processor, or the transceiver 1308, or a communications manager, or other components or combinations of components of the wireless communication device 1300. The processing system of the wireless communication device 1300 may interface with other components of the wireless communication device 1300, and may process information received from other components (such as inputs or signals) or output information to other components. For example, a chip or modem of the wireless communication device 1300 may include a processing system, a first interface to output information and a second interface to obtain information. In some implementations, the first interface may refer to an interface between the processing system of the chip or modem and a transmitter, such that the wireless communication device 1300 may transmit information output from the chip or modem. In some implementations, the second interface may refer to an interface between the processing system of the chip or modem and a receiver, such that the wireless communication device 1300 may obtain information or signal inputs, and the information may be passed to the processing system. A person having ordinary skill in the art will readily recognize that the first interface also may obtain information or signal inputs, and the second interface also may output information or signal outputs.

The header protection logic 1302 is capable of, configured to, or operable to generate header integrity check information based on one or more fields of a header for a first data packet. For example, the header integrity check information may include or correspond to the header integrity check information 610 of FIG. 6.

The payload protection logic 1304 is capable of, configured to, or operable to generate message integrity check information based on a payload of the first data packet. The message integrity check information is distinct from the header integrity check information. For example, the message integrity check information may include or correspond to the MIC information 612 of FIG. 6.

The packet generation logic 1306 is capable of, configured to, or operable to generate, based on the header integrity check information, the first data packet or a second data packet. For example, the first data packet may include or correspond to the first data packet 628 of FIG. 6, and the second data packet may include or correspond to the second data packet 629 of FIG. 6.

The transceiver 1308 is capable of, configured to, or operable to transmit messages or signals, receive messages or signals, or both, to enable wireless communication with one or more other wireless communication devices, such as the second wireless communication device 650 of FIG. 6 or the wireless communication device 1400 of FIG. 14.

FIG. 14 shows a block diagram of an example wireless communication device 1400 that supports header integrity verification according to some aspects of the present disclosure. In some examples, the wireless communication device 1400 is configured or operable to perform the process 1200 described with reference to FIG. 12. In various examples, the wireless communication device 1400 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”).

In some examples, the wireless communication device 1400 can be a device for use in a STA, such as STA 104 described with reference to FIG. 1, or in an AP, such as AP 102 described with reference to FIG. 1. In some other examples, the wireless communication device 1400 can be a STA or an AP that includes such a chip, SoC, chipset, package or device as well as multiple antennas. The wireless communication device 1400 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1400 also includes or can be coupled with an application processor which may be further coupled with another memory. In some examples, the wireless communication device 1400 further includes a user interface (UI) (such as a touchscreen or keypad) and a display, which may be integrated with the UI to form a touchscreen display. In some examples, the wireless communication device 1400 may further include one or more sensors such as, for example, one or more inertial sensors, accelerometers, temperature sensors, pressure sensors, or altitude sensors.

The wireless communication device 1400 includes header verification logic 1402, payload verification logic 1404, packet processing logic 1406, and a transceiver 1408. Portions of one or more of the components 1402, 1404, 1406, and 1408 may be implemented at least in part in hardware or firmware. For example, the transceiver 1408 may include or correspond to a transmitter, a receiver, or a combination of a transmitter and a receiver (e.g., a transceiver). In some examples, at least some of the components 1402, 1404, 1406, and 1408 are implemented at least in part by a processor and as software stored in a memory. For example, portions of one or more of the components 1402, 1404, or 1406 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 1400). For example, a processing system of the wireless communication device 1400 may refer to a system including the various other components or subcomponents of the wireless communication device 1400, such as the processor, or the transceiver 1408, or a communications manager, or other components or combinations of components of the wireless communication device 1400. The processing system of the wireless communication device 1400 may interface with other components of the wireless communication device 1400, and may process information received from other components (such as inputs or signals) or output information to other components. For example, a chip or modem of the wireless communication device 1400 may include a processing system, a first interface to output information and a second interface to obtain information. In some implementations, the first interface may refer to an interface between the processing system of the chip or modem and a transmitter, such that the wireless communication device 1400 may transmit information output from the chip or modem. In some implementations, the second interface may refer to an interface between the processing system of the chip or modem and a receiver, such that the wireless communication device 1400 may obtain information or signal inputs, and the information may be passed to the processing system. A person having ordinary skill in the art will readily recognize that the first interface also may obtain information or signal inputs, and the second interface also may output information or signal outputs.

The header verification logic 1402 is capable of, configured to, or operable to perform a header integrity check on a header of a first data packet or a second data packet based on integrity check information included in the first data packet. For example, the integrity check information may include or correspond to the header integrity check information 610 of FIG. 6 or the integrity check information 670 of FIG. 6.

The payload verification logic 1404 is capable of, configured to, or operable to a payload integrity check on a payload of the first data packet or the second data packet based on the integrity check information included in the first data packet or separate message integrity check information included in the first data packet. For example, the integrity check information may include or correspond to the header integrity check information 610 of FIG. 6 or the integrity check information 670 of FIG. 6, and the message integrity check information may include or correspond to the MIC information 612 of FIG. 6.

The packet processing logic 1406 is capable of, configured to, or operable to process, based on success of the header integrity check, the header of the first data packet or the header of the second data packet. For example, based on success of a header integrity check performed on the header of the first data packet 628 of FIG. 6, the header of the first data packet 628 may be processed. As another example, based on success of a header integrity check performed on the header of the second data packet 629 of FIG. 6, the header of the second data packet 629 may be processed.

The transceiver 1408 is capable of, configured to, or operable to transmit messages or signals, receive messages or signals, or both, to enable wireless communication with one or more other wireless communication devices, such as the first wireless communication device 602 of FIG. 6 or the wireless communication device 1300 of FIG. 13.

Implementation examples are described in the following numbered clauses:

Clause 1: A method for wireless communication performable at a wireless communication device, the method including: generating header integrity check information based on one or more fields of a header for a first data packet, the header integrity check information being distinct from message integrity check information for the first data packet, the message integrity check information being based on a payload of the first data packet; generating, based on the header integrity check information, the first data packet or a second data packet; and transmitting the first data packet or the second data packet.

Clause 2: The method of clause 1, where the header integrity check information is generated based further on one or both of: a second packet number that is distinct from a first packet number included in the header of the first data packet; or a second encryption key that is distinct from a first encryption key used to encrypt the payload of the first data packet.

Clause 3: The method of clause 2, where the first packet number is included in a first range of packet numbers that is allocated to payload encryption, and where the second packet number is included in a second range of packet numbers that is allocated to header integrity.

Clause 4: The method of clause 2, where the second packet number is greater than the first packet number, and where the first packet number and the second packet number are included in a range of packet numbers that is allocated to payload encryption.

Clause 5: The method of clause 2, where the second packet number includes at least a portion of a timestamp associated with transmission of the first data packet.

Clause 6: The method of clause 2, further including generating a pair of pairwise encryption keys during association with another wireless communication device, where the pair of pairwise encryption keys includes the first encryption key and the second encryption key.

Clause 7: The method of clause 2, where the header of the first data packet includes a first subset of fields that corresponds to a MAC header, a second subset of fields that corresponds to an encryption header, and a header integrity field, and where the header integrity field includes at least a portion of the second packet number or at least a portion of the second packet number and an encryption key identifier.

Clause 8: The method of clause 1, further including transmitting one or more dummy frames associated with generation of the header integrity check information, where the wireless communication device generates the first data packet based on the header integrity check information and transmits the first data packet after transmission of the one or more dummy frames.

Clause 9: The method of clause 1, further including generating the message integrity check information based on the payload of the first data packet and one or more particular fields of a MAC header included in the header of the first data packet.

Clause 10: A wireless communication device, including at least one memory and at least one processor communicatively coupled with the at least one memory, the at least one processor operable to cause the wireless communication device to: generate header integrity check information based on one or more fields of a header for a first data packet, the header integrity check information being distinct from message integrity check information for the first data packet, the message integrity check information being based on a payload of the first data packet; generate, based on the header integrity check information, the first data packet or a second data packet; and transmit the first data packet or the second data packet.

Clause 11: The wireless communication device of clause 10, where the wireless communication device is configured to generate the first data packet and to transmit the first data packet, and where a header integrity check field of the header of the first data packet includes the header integrity check information.

Clause 12: The wireless communication device of clause 11, where the header of the first data packet includes a first subset of fields that corresponds to a MAC header and a second subset of fields that corresponds to an encryption header, and where the header integrity check field is located in the header between the MAC header and the encryption header or between the encryption header and an end of the header.

Clause 13: The wireless communication device of clause 10, where the wireless communication device is configured to generate the first data packet and to transmit the first data packet, and where a message integrity check field of the first data packet includes a value that is based on the header integrity check information and the message integrity check information.

Clause 14: The wireless communication device of clause 10, where the wireless communication device is configured to generate the second data packet and to transmit the second data packet after transmission of the first data packet, and where a field of a header of the second data packet or a field of the second data packet is based on the header integrity check information.

Clause 15: The wireless communication device of clause 10, where the payload of the first data packet includes an encrypted data unit, the first data packet includes a data frame or a management frame, or the payload of the first data packet includes a null value and the first data packet includes a null frame.

Clause 16: A method for wireless communication performable at a wireless communication device, the method including: receiving a first data packet that includes integrity check information that is based on one or more fields of a header of the first data packet or one or more fields of a header of a second data packet that is received prior to reception of the first data packet; performing, based on the integrity check information, a header integrity check on the header of the first data packet or the header of the second data packet; and processing, based on success of the header integrity check, the header of the first data packet or the header of the second data packet.

Clause 17: The method of clause 16, further including discarding, based on failure of the header integrity check, the first data packet or the second data packet without processing the first data packet or the second data packet.

Clause 18: The method of clause 16, where the header of the first data packet or the header of the second data packet includes a first subset of fields that corresponds to a MAC header, a second subset of fields that corresponds to an encryption header, and a header integrity check field, where the encryption header includes a first packet number and a first encryption key identifier that corresponds to a first encryption key, and where the header integrity check field includes at least a portion of a second packet number that is distinct from the first packet number or at least a portion of the second packet number and a second encryption key identifier that corresponds to a second encryption key.

Clause 19: The method of clause 18, where the first packet number is included in a first range of packet numbers that is allocated to payload encryption, and where the second packet number is included in a second range of packet numbers that is allocated to header integrity.

Clause 20: The method of clause 18, where the second packet number is greater than the first packet number, and where the first packet number and the second packet number are included in a range of packet numbers that is allocated to payload encryption.

Clause 21: The method of clause 18, further including generating a pair of pairwise encryption keys during association with another wireless communication device, where the pair of pairwise encryption keys includes the first encryption key and the second encryption key.

Clause 22: The method of clause 18, where the integrity check information is based on a payload of the first data packet or a payload of the second data packet, and one or more particular fields of the MAC header.

Clause 23: A wireless communication device, including at least one memory and at least one processor communicatively coupled with the at least one memory, the at least one processor operable to cause the wireless communication device to: receive a first data packet that includes integrity check information that is based on one or more fields of a header of the first data packet or one or more fields of a header of a second data packet that is received prior to reception of the first data packet; perform, based on the integrity check information, a header integrity check on the header of the first data packet or the header of the second data packet; and process, based on success of the header integrity check, the header of the first data packet or the header of the second data packet.

Clause 24: The wireless communication device of clause 23, where the integrity check information includes header integrity check information included in a header integrity check field of the header of the first data packet.

Clause 25: The wireless communication device of clause 24, where the header of the first data packet includes a first subset of fields that corresponds to a MAC header and a second subset of fields that corresponds to an encryption header, and where the header integrity check field is located in the header between the MAC header and the encryption header or between the encryption header and an end of the header.

Clause 26: The wireless communication device of clause 23, where the integrity check information is included in a message integrity check field of the first data packet, and where the integrity check information corresponds to header integrity and message integrity.

Clause 27: The wireless communication device of clause 26, where the wireless communication device, to perform the header integrity check, is configured to: generate header integrity check information based on the one or more fields of the header of the first data packet; generate message integrity check information based on a payload of the first data packet; generate an integrity check value based on the header integrity check information and the message integrity check information; and compare the integrity check information to the integrity check value.

Clause 28: The wireless communication device of clause 23, where the integrity check information is based on the one or more fields of the header of the second data packet.

Clause 29: The wireless communication device of clause 23, where the second data packet includes a dummy frame, and where the integrity check information is based on the one or more fields of the header of the first data packet.

Clause 30: The wireless communication device of clause 23, where a payload of the first data packet includes an encrypted data unit, the first data packet includes a data frame or a management frame, or the payload of the first data packet includes a null value and the first data packet includes a null frame.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method for wireless communication performable at a wireless communication device, the method comprising:
generating header integrity check information based on one or more fields of a header for a first data packet, the header integrity check information being distinct from message integrity check information for the first data packet, the message integrity check information being based on a payload of the first data packet;
generating, based on the header integrity check information, the first data packet or a second data packet; and
transmitting the first data packet or the second data packet.

2. The method of claim 1, wherein the header integrity check information is generated based further on one or both of:
a second packet number that is distinct from a first packet number included in the header of the first data packet; or
a second encryption key that is distinct from a first encryption key used to encrypt the payload of the first data packet.

3. The method of claim 2, wherein the first packet number is included in a first range of packet numbers that is allocated to payload encryption, and wherein the second packet number is included in a second range of packet numbers that is allocated to header integrity.

4. The method of claim 2, wherein the second packet number is greater than the first packet number, and wherein the first packet number and the second packet number are included in a range of packet numbers that is allocated to payload encryption.

5. The method of claim 2, wherein the second packet number comprises at least a portion of a timestamp associated with transmission of the first data packet.

6. The method of claim 2, further comprising:
generating a pair of pairwise encryption keys during association with another wireless communication device, wherein the pair of pairwise encryption keys includes the first encryption key and the second encryption key.

7. The method of claim 2, wherein the header of the first data packet includes a first subset of fields that corresponds to a medium access control (MAC) header, a second subset of fields that corresponds to an encryption header, and a header integrity field, and wherein the header integrity field includes:
at least a portion of the second packet number; or
at least a portion of the second packet number and an encryption key identifier.

8. The method of claim 1, further comprising:
transmitting one or more dummy frames associated with generation of the header integrity check information, wherein the wireless communication device generates the first data packet based on the header integrity check information and transmits the first data packet after transmission of the one or more dummy frames.

9. The method of claim 1, further comprising:
generating the message integrity check information based on the payload of the first data packet and one or more particular fields of a medium access control (MAC) header included in the header of the first data packet.

10. A wireless communication device, comprising:
at least one memory; and
at least one processor communicatively coupled with the at least one memory, the at least one processor operable to cause the wireless communication device to:
generate header integrity check information based on one or more fields of a header for a first data packet, the header integrity check information being distinct from message integrity check information for the first data packet, the message integrity check information being based on a payload of the first data packet;
generate, based on the header integrity check information, the first data packet or a second data packet; and
transmit the first data packet or the second data packet.

11. The wireless communication device of claim 10, wherein the wireless communication device is configured to generate the first data packet and to transmit the first data packet, and wherein a header integrity check field of the header of the first data packet includes the header integrity check information.

12. The wireless communication device of claim 11, wherein the header of the first data packet includes a first subset of fields that corresponds to a medium access control (MAC) header and a second subset of fields that corresponds to an encryption header, and wherein the header integrity check field is located in the header between the MAC header and the encryption header or between the encryption header and an end of the header.

13. The wireless communication device of claim 10, wherein the wireless communication device is configured to generate the first data packet and to transmit the first data packet, and wherein a message integrity check field of the first data packet includes a value that is based on the header integrity check information and the message integrity check information.

14. The wireless communication device of claim 10, wherein the wireless communication device is configured to generate the second data packet and to transmit the second data packet after transmission of the first data packet, and wherein a field of a header of the second data packet or a field of the second data packet is based on the header integrity check information.

15. The wireless communication device of claim 10, wherein:
the payload of the first data packet comprises an encrypted data unit;
the first data packet comprises a data frame or a management frame; or
the payload of the first data packet comprises a null value and the first data packet comprises a null frame.

16. A method for wireless communication performable at a wireless communication device, the method comprising:
receiving a first data packet that includes integrity check information that is based on one or more fields of a header of the first data packet or one or more fields of a header of a second data packet that is received prior to reception of the first data packet;
performing, based on the integrity check information, a header integrity check on the header of the first data packet or the header of the second data packet; and
processing, based on success of the header integrity check, the header of the first data packet or the header of the second data packet.

17. The method of claim 16, further comprising:
discarding, based on failure of the header integrity check, the first data packet or the second data packet without processing the first data packet or the second data packet.

18. The method of claim 16, wherein the header of the first data packet or the header of the second data packet includes a first subset of fields that corresponds to a medium access control (MAC) header, a second subset of fields that corresponds to an encryption header, and a header integrity check field, wherein the encryption header includes a first packet number and a first encryption key identifier that corresponds to a first encryption key, and wherein the header integrity check field includes:
at least a portion of a second packet number that is distinct from the first packet number; or
at least a portion of the second packet number and a second encryption key identifier that corresponds to a second encryption key.

19. The method of claim 18, wherein the first packet number is included in a first range of packet numbers that is allocated to payload encryption, and wherein the second packet number is included in a second range of packet numbers that is allocated to header integrity.

20. The method of claim 18, wherein the second packet number is greater than the first packet number, and wherein the first packet number and the second packet number are included in a range of packet numbers that is allocated to payload encryption.

21. The method of claim 18, further comprising:
generating a pair of pairwise encryption keys during association with another wireless communication device, wherein the pair of pairwise encryption keys includes the first encryption key and the second encryption key.

22. The method of claim 18, wherein the integrity check information is based on:
a payload of the first data packet or a payload of the second data packet; and
one or more particular fields of the MAC header.

23. A wireless communication device, comprising:
at least one memory; and
at least one processor communicatively coupled with the at least one memory, the at least one processor operable to cause the wireless communication device to:
receive a first data packet that includes integrity check information that is based on one or more fields of a header of the first data packet or one or more fields of a header of a second data packet that is received prior to reception of the first data packet;
perform, based on the integrity check information, a header integrity check on the header of the first data packet or the header of the second data packet; and
process, based on success of the header integrity check, the header of the first data packet or the header of the second data packet.

24. The wireless communication device of claim 23, wherein the integrity check information comprises header integrity check information included in a header integrity check field of the header of the first data packet.

25. The wireless communication device of claim 24, wherein the header of the first data packet includes a first subset of fields that corresponds to a medium access control (MAC) header and a second subset of fields that corresponds to an encryption header, and wherein the header integrity check field is located in the header between the MAC header and the encryption header or between the encryption header and an end of the header.

26. The wireless communication device of claim 23, wherein the integrity check information is included in a message integrity check field of the first data packet, and wherein the integrity check information corresponds to header integrity and message integrity.

27. The wireless communication device of claim 26, wherein the wireless communication device, to perform the header integrity check, is configured to:
generate header integrity check information based on the one or more fields of the header of the first data packet;
generate message integrity check information based on a payload of the first data packet;
generate an integrity check value based on the header integrity check information and the message integrity check information; and
compare the integrity check information to the integrity check value.

28. The wireless communication device of claim 23, wherein the integrity check information is based on the one or more fields of the header of the second data packet.

29. The wireless communication device of claim 23, wherein the second data packet comprises a dummy frame, and wherein the integrity check information is based on the one or more fields of the header of the first data packet.

30. The wireless communication device of claim 23, wherein:
a payload of the first data packet comprises an encrypted data unit;
the first data packet comprises a data frame or a management frame; or
the payload of the first data packet comprises a null value and the first data packet comprises a null frame.
